(19) United States
(12) Patent Application Publication
(10) Pub. No.: US 2004/0085459 A1
(43) Pub. Date: May 6, 2004

(54) Image processing device, image processing program, and image processing method

(75) Inventors: Hideo Hoshuyama, Kawasaki-shi (JP); Masahiro Suzuki, Inzai-shi (JP); Ritsuko Fuyuki, Tokyo (JP)

Correspondence Address: OLIFF & BERRIDGE, PLC, P.O. BOX 19928, ALEXANDRIA, VA, 22320, US

(73) Assignee: NIKON CORPORATION, Tokyo (JP)

(21) Appl. No.: 10/358,457

(22) Filed: Feb. 5, 2003

(30) Foreign Application Priority Data
Feb. 12, 2002 (JP) 2002-034442
Feb. 12, 2002 (JP) 2002-034443
Feb. 12, 2002 (JP) 2002-034444
Feb. 12, 2002 (JP) 2002-034445

(51) Int. Cl. H04N 9/73

(52) U.S. Cl. 348/223.1

(57) ABSTRACT

An image processing apparatus of the invention comprises an image processing part and a control part. The image processing part performs an image processing on an image signal. The control part obtains an influential factor of the image signal to control level of the image processing in accordance with the influential factor, the influential factor affecting a result of the image processing. The control part preferably evaluates reliability of the influential factor to adjust a level range of the image processing in accordance with the evaluated reliability. Such operation makes it possible to achieve a more effective image processing by widening level range upon obtaining a very reliable influential factor. Also, upon obtaining a not reliable influential factor, the level range is narrowed so that the image processing can be prevented from excessively varying.

### BACKGROUND OF THE INVENTION

1. Field of the Invention

The present invention relates to an image processing apparatus and a method for performing an image processing on an image signal generated by an imaging part.

The present invention also relates to an image processing program for implementing the image processing apparatus on a computer.

2. Description of the Related Art

(First Related Art Reference)

There is a known electronic camera that allows the user to manually select his or her desired adjustment level of color reproduction from a plurality of setting levels. Such an electronic camera generates image signals of a bright color upon the user's selection of a setting level at which chromaticness is most emphasized. These image signals are suitable for directly printing on a printer or for direct display on a home page. On the other hand, upon the user's selection of a “setting level at which chromaticness is not so emphasized”, image signals without color saturation can be generated. These image signals containing much subtle color information are suitable for image processing on a personal computer.

However, the color representation of an image signal is susceptible to variances in the color temperature of the light source, a color and brightness of an object, an imaging condition of the electronic camera, and so forth. If the user selects the forgoing setting level at which chromaticness is most emphasized” without taking the variations in the color representation into consideration, there may be problems that the chromaticness is emphasized more than necessary or that the color may appear unnatural.

(Second Related Art Reference)

There is another known electronic camera that analyzes the gradation of an image signal (for example histogram statistics of each color component) and automatically adjusts the gradation conversion characteristic of the image signal. This camera is capable of enhancing the contrast in the medium luminance region while properly preventing the gradations in the low and high luminance regions.

For representing the gradation of an image signal, known are high key representation in which a mostly white object is a main object on the screen and low key representation in which a mostly black object is a main object on the screen. In a case where the gradation conversion characteristic according to the forgoing luminance histogram is applied to an image signal having such a particular gradation, a desired high key representation or low key representation may be converted into a mediocre representation.

(Third Related Art Reference)

There is another known image processing apparatus that suppresses noise in an image signal using a local sum-of-product calculation or a median filter (for example, refer to “Handbook on Image Analysis,” compiled by Mikio Takagi, University of Tokyo Press, 1991).

It is difficult, however, to distinguish detail components of an image signal (a small amplitude signal) from noise in an image processing. Thus, high noise suppression may lead to obstructive loss in details of the image signal.

(Fourth Related Art Reference)

There is another known electronic camera that performs gain adjustment of the chromaticness level of an image signal depending on the luminance level thereof. Such a camera can reduce color noise in the low luminance region by suppressing the chromaticness level in the low luminance region of an image signal. This camera is also capable of preventing an unnatural color in a high luminance region by suppressing the chromaticness level in the high luminance region of an image signal (disclosed in Japanese Unexamined Patent Application Publication No. Hei 5-244623, for example).

As described above, the color representation of an image signal easily varies with variances in the imaging conditions. If the user reduces color noise at a constant rate in the low luminance region without taking the variations in the color representation into account, there may arise a problem of not sufficiently removing color noise in the low luminance region but excessively losing the hue of the low luminance region instead.

### SUMMARY OF THE INVENTION

In view of solving the above-described problems, an object of the present invention is to provide a technology for properly and flexibly adjusting an image processing in accordance with a variety of image signals.

In the following, the present invention will be described.

(1) An image processing apparatus of the present invention comprises an image processing part and a control part. The image processing part is configured to perform an image processing on an image signal. The control part is configured to obtain an influential factor of the image signal, the influential factor that influences a result of the image processing. The control part controls a level of the image processing in accordance with the obtained influential factor.

(2) The control part is preferably configured to evaluate reliability of the influential factor and adjust a level range of the image processing according to the evaluated reliability. The control part widens the level range of the image processing, upon evaluating the influential factor as highly reliable, which achieves a more effective image processing. On the other hand, the control part narrows the level range thereof, upon evaluating the influential factor as not reliable, which enables prevention of excessive variance in the image processing.

(3) Preferably, the control part evaluates the reliability of the influential factor based on how much the influential factor occupies the entire image signal to adjust the level range of the image processing in accordance with the evaluated reliability. The control part widens the level range of the image processing, upon evaluating an influential factor as affecting a large area of the image, which achieves a more effective image processing. The control part narrows the level range thereof, upon evaluating an influential factor as largely fluctuating on the screen, which enables prevention of excessive variance in the image processing.

(4) The control part is preferably configured to evaluate the reliability of the influential factor based on how much the influential factor is reflected in the entire image signal and adjust the level range of the image processing in accordance with the evaluated reliability. The control part increases the level range of the image processing, upon evaluating the influential factor as being highly reflected in the image signal, which achieves a more effective image processing. On the other hand, upon evaluating the influential factor as being not reflected much in the image signal, the control part decreases the level range of the image processing, which allows prevention of excessive variance in the image processing.

(5) The image processing part preferably comprises a color reproduction adjusting part. The color reproduction adjusting part is configured to vary chromaticness of the image signal so as to control the degree of adjustment of color reproduction for the image signal. The control part comprises a color reproduction control part. The color reproduction control part is configured to obtain color related information, which is an influential factor affecting color representation of the image signal, and to control a degree of an adjustment of the color reproduction in accordance with the obtained color related information.

Structuring the image processing apparatus in this way makes it possible to control the degree of the adjustment of the color reproduction, dealing with variations in the color representation which are inferred from the color related information.

(6) At least one piece of the color related information is preferably imaging condition(s) for the image signal. In this case, the color reproduction control part is configured to obtain the imaging condition for the image signal and control the degree of adjustment of the color reproduction in accordance with the obtained imaging condition.

Structuring the image processing apparatus in this way makes it possible to control the degree of the adjustment of the color reproduction, dealing with variations in the color representation which are inferred from the imaging condition.

(7) At least one piece of the color related information is preferably analysis result(s) of the image signal. In this case, the color reproduction control part is configured to obtain the analysis result of the image signal and control the degree of adjustment of the color reproduction according to the obtained analysis result.

Structuring the image processing apparatus in this way makes it possible to control the degree of the adjustment of the color reproduction, dealing with variations in the color representation which are inferred from the analysis result.

(8) At least one of the imaging conditions is preferably a photometric value of a field. In this case, the color reproduction control part is configured to obtain the photometric value at capture of the image signal and control the degree of adjustment of the color reproduction according to the obtained photometric value.

Structuring the image processing apparatus in this way makes it possible to control the degree of the adjustment of the color reproduction, dealing with variations in the color representation which are inferred from the photometric value.

(9) At least one of the imaging conditions is preferably a divided photometric value of a field. In this case, the color reproduction control part is configured to obtain the divided photometric value at capture of the image signal and control the degree of adjustment of the color reproduction in accordance with a photometric contrast which is obtained from the divided photometric value.

Structuring the image processing apparatus in this way makes it possible to control the degree of the adjustment of the color reproduction, dealing with variations in the color representation which are inferred from the photometric contrast.

(10) At least one of the imaging conditions is preferably information on illumination to an object. In this case, the color reproduction control part is configured to obtain the information on the illumination at capture of the image signal and control the degree of adjustment of the color reproduction in accordance with the obtained illumination information.

Structuring the image processing apparatus in this way makes it possible to control the degree of the adjustment of the color reproduction, dealing with variations in the color representation which are inferred from the illumination information.

(11) At least one of the imaging conditions is preferably an exposure condition of an imaging part. In this case, the color reproduction control part is configured to obtain the exposure condition at capture of the image signal and control the degree of adjustment of the color reproduction in accordance with the obtained exposure condition.

Structuring the image processing apparatus in this way makes it possible to control the degree of the adjustment of the color reproduction, dealing with variations in the color representation which are inferred from the exposure condition.

(12) At least one of the imaging conditions is preferably information on a lens of an imaging part. In this case, the color reproduction control part is configured to obtain the lens information at capture of the image signal and control the degree of adjustment of the color reproduction according to the obtained lens information.

Structuring the image processing apparatus in this way makes it possible to control the degree of the adjustment of the color reproduction, dealing with variations in the color representation which are inferred from the lens information.

(13) At least one of the imaging conditions is preferably image sensitivity of an imaging part. In this case, the color reproduction control part is configured to obtain the image sensitivity at capture of the image signal and control the degree of adjustment of the color reproduction according to the obtained image sensitivity.

Structuring the image processing apparatus in this way makes it possible to control the degree of the adjustment of the color reproduction, dealing with variations in the color representation which are inferred from the image sensitivity.

(14) At least one of the analysis results is preferably color information on a color of the image signal. In this case, the color reproduction control part is configured to obtain the color information on the image signal and control the degree of adjustment of the color reproduction in accordance with the obtained color information.

Structuring the image processing apparatus in this way makes it possible to control the degree of the adjustment of the color reproduction, dealing with variations in the color representation which are determined from the color information.

(15) At least one of the analysis results is a preferably color occupancy that represents a screen occupancy of a color of the image signal. In this case, the color reproduction control part is configured to obtain the color occupancy of the image signal and control the degree of adjustment of the color reproduction according to the obtained color occupancy.

Structuring the image processing apparatus in this way makes it possible to control the degree of the adjustment of the color reproduction, dealing with variations in the color representation which are determined from the color occupancy.

(16) The image processing part preferably comprises a gradation converting part. The gradation converting part is configured to convert gradation of the image signal. The control part comprises a gradation conversion control part. The gradation conversion control part is configured to obtain gradation related information, which is an influential factor affecting gradation representation of the image signal, and to change a gradation conversion characteristic of the gradation converting part in accordance with the obtained gradation related information.

Structuring the image processing apparatus in this way makes it possible to change the gradation conversion characteristic, taking into consideration a current gradation representation which is inferred from the gradation related information.

(17) At least one piece of the gradation related information is preferably imaging condition(s) of the image signal. In this case, the gradation conversion control part is configured to obtain the imaging condition of the image signal and change the gradation conversion characteristic in accordance with the obtained imaging condition.

Structuring the image processing apparatus in this way makes it possible to change the gradation conversion characteristic, taking into consideration a current gradation representation which is inferred from the gradation related information.

(18) At least one piece of the gradation related information is preferably analysis result(s) of the image signal. In this case, the gradation conversion control part is configured to obtain the analysis result of the image signal and change the gradation conversion characteristic according to the obtained analysis result.

Structuring the image processing apparatus in this way makes it possible to change the gradation conversion characteristic, taking into consideration a current gradation representation which is inferred from the analysis result.

(19) At least one of the imaging conditions is preferably a photometric value of a field. In this case, the gradation conversion control part is configured to obtain the photometric value at capture of the image signal and change the gradation conversion characteristic in accordance with the obtained photometric value.

Structuring the image processing apparatus in this way makes it possible to change the gradation conversion characteristic, taking into consideration a current gradation representation which is inferred from the photometric value.

(20) At least one of the imaging conditions is preferably a divided photometric value of a field. In this case, the gradation conversion control part is configured to obtain the divided photometric value at capture of the image signal and change the gradation conversion characteristic in accordance with a photometric contrast which is obtained from the divided photometric value.

Structuring the image processing apparatus in this way makes it possible to change the gradation conversion characteristic, taking into consideration a current gradation representation which is inferred from the photometric contrast.

(21) At least one of the imaging conditions is preferably information on illumination to an object. In this case, the gradation conversion control part is configured to obtain the information on illumination at capture of the image signal and change the gradation conversion characteristic in accordance with the obtained information.

Structuring the image processing apparatus in this way makes it possible to change the gradation conversion characteristic, taking into consideration a current gradation representation which is inferred from the information on illumination.

(22) At least one of the imaging conditions is preferably an exposure condition of an imaging part. In this case, the gradation conversion control part is configured to obtain the exposure condition at capture of the image signal and change the gradation conversion characteristic according to the obtained exposure condition.

Structuring the image processing apparatus in this way makes it possible to change the gradation conversion characteristic, taking into consideration a current gradation representation which is inferred from the exposure condition.

(23) At least one of the imaging conditions is preferably information on a lens of an imaging part. In this case, the gradation conversion control part is configured to obtain the lens information at capture of the image signal and change the gradation conversion characteristic in accordance with the obtained lens information.

Structuring the image processing apparatus in this way makes it possible to change the gradation conversion characteristic, taking into consideration a current gradation representation which is inferred from the lens information.

(24) At least one of the imaging conditions is preferably image sensitivity of an imaging part. In this case, the gradation conversion control part is configured to obtain the image sensitivity at capture of the image signal and change the gradation conversion characteristic in accordance with the obtained image sensitivity.

Structuring the image processing apparatus in this way makes it possible to change the gradation conversion characteristic, taking into consideration a current gradation representation which is inferred from the image sensitivity.

(25) At least one of the analysis results is preferably color information on a color of the image signal. In this case, the gradation conversion control part is configured to obtain the color information on the image signal and change the gradation conversion characteristic in accordance with the obtained color information.

Structuring the image processing apparatus in this way makes it possible to change the gradation conversion characteristic, taking into consideration a current gradation representation which is inferred from the color information.

(26) At least one of the analysis results is preferably a color occupancy that represents screen occupancy of a color of the image signal. In this case, the gradation conversion control part is configured to obtain the color occupancy of the image signal and change the gradation conversion characteristic in accordance with the obtained color occupancy.

Structuring the image processing apparatus in this way makes it possible to change the gradation conversion characteristic, taking into consideration a current gradation representation which is inferred from the color occupancy.

(27) The image processing part preferably comprises a noise suppressing part. The noise suppressing part is configured to suppress noise in the image signal. On the other hand, the control part comprises a noise suppression control part. The noise suppression control part is configured to obtain noise related information, which is an influential factor affecting noise representation of the image signal, and to control a degree of noise suppression of the noise suppressing part in accordance with the obtained noise related information.

Structuring the image processing apparatus in this way makes it possible to control the degree of noise suppression, taking into consideration a current noise representation which is inferred from the noise related information.

(28) At least one piece of the noise related information is preferably imaging condition(s) of the image signal. In this case, the noise suppression control part is configured to obtain the imaging condition of the image signal and control the degree of noise suppression in accordance with the obtained imaging condition.

Structuring the image processing apparatus in this way makes it possible to control the degree of noise suppression, taking into consideration a current noise representation which is inferred from the imaging condition.

(29) At least one piece of the noise related information is preferably analysis result(s) of the image signal. In this case, the noise suppression control part is configured to obtain the analysis result of the image signal and control the degree of noise suppression in accordance with the obtained analysis result.

Structuring the image processing apparatus in this way makes it possible to control the degree of noise suppression, taking into consideration a current noise representation which is inferred from the analysis result.

(30) At least one of the imaging conditions is preferably a photometric value of a field. In this case, the noise suppression control part is configured to obtain the photometric value at capture of the image signal and control the degree of noise suppression in accordance with the obtained photometric value.

Structuring the image processing apparatus in this way makes it possible to control the degree of noise suppression, taking into consideration a current noise representation which is inferred from the photometric value.

(31) At least one of the imaging conditions is preferably a divided photometric value of a field. In this case, the noise suppression control part is configured to obtain the divided photometric value at capture of the image signal and control the degree of noise suppression in accordance with a photometric contrast obtained from the divided photometric value.

Structuring the image processing apparatus in this way makes it possible to control the degree of noise suppression, taking into consideration a current noise representation which is inferred from the photometric contrast.

(32) At least one of the imaging conditions is preferably information on illumination to an object. In this case, the noise suppression control part is configured to obtain the information on illumination at capture of the image signal and control the degree of noise suppression in accordance with the obtained information on illumination.

Structuring the image processing apparatus in this way makes it possible to control the degree of noise suppression, taking into consideration a current noise representation which is inferred from the information on illumination.

(33) At least one of the imaging conditions is preferably an exposure condition of an imaging part. In this case, the noise suppression control part is configured to obtain the exposure condition at capture of the image signal and control the degree of noise suppression in accordance with the obtained exposure condition.

Structuring the image processing apparatus in this way makes it possible to control the degree of noise suppression, taking into consideration a current noise representation which is inferred from the exposure condition.

(34) At least one of the imaging conditions is preferably information on a lens of an imaging part. In this case, the noise suppression control part is configured to obtain the lens information at capture of the image signal and control the degree of noise suppression in accordance with the obtained lens information.

Structuring the image processing apparatus in this way makes it possible to control the degree of noise suppression, taking into consideration a current noise representation which is inferred from the lens information.

(35) At least one of the analysis results is preferably color information on a color of the image signal. In this case, the noise suppression control part is configured to obtain the color information on the image signal and control the degree of noise suppression in accordance with the obtained color information.

Structuring the image processing apparatus in this way makes it possible to control the degree of noise suppression, taking into consideration a current noise representation which is inferred from the color information.

(36) At least one of the analysis results is preferably a color occupancy that represents screen occupancy of a color of the image signal. In this case, the noise suppression control part is configured to obtain the color occupancy of the image signal and control the degree of noise suppression in accordance with the obtained color occupancy.

Structuring the image processing apparatus in this way makes it possible to control the degree of noise suppression, taking into consideration a current noise representation which is inferred from the color occupancy.

(37) The control part preferably comprises a chromaticness modulation control part. The chromaticness modulation control part is configured to obtain color related information as an influential factor affecting color representation of the image signal, and to change chromaticness modulation characteristic in accordance with the obtained color related information. The chromaticness modulation characteristic defines a gain of a chromaticness level to a luminance level. On the other hand, the image processing part comprises a chromaticness modulating part. The chromaticness modulating part is configured to adjust the gain of the chromaticness level corresponding to the luminance level of the image signal, in accordance with the chromaticness modulation characteristic controlled by the chromaticness modulation control part.

Structuring the image processing apparatus in this way makes it possible to change the chromaticness modulation characteristic, dealing with the variations in the color representation which are inferred from the color related information.

(38) At least one piece of the color related information is preferably a degree of adjustment of the color reproduction which has been made on the image signal. In this case, the chromaticness modulation control part is configured to obtain the degree of adjustment of the color reproduction and change the chromaticness modulation characteristic in accordance with the obtained degree of the adjustment of the color reproduction.

Structuring the image processing apparatus in this way makes it possible to change the chromaticness modulation characteristic, dealing with the variations in the color representation which are inferred from the degree of adjustment of the color reproduction.

Note that the “adjustment of color reproduction” refers to color adjustment made uniformly on the entire image independent from the luminance level. In contrast, the chromaticness modulation processing that the chromaticness modulating part performs is a processing of varying a gain of the chromaticness level in accordance with the luminance level. Accordingly, the “adjustment of color reproduction” and the “chromaticness modulation processing” should be clearly distinguished.

(39) At least one piece of the color related information is preferably image sensitivity of an imaging part. In this case, the chromaticness modulation control part is configured to obtain the image sensitivity at capture of the image signal and change the chromaticness modulation characteristic in accordance with the obtained image sensitivity.

Structuring the image processing apparatus in this way makes it possible to change the chromaticness modulation characteristic, dealing with the variations in the color representation which are inferred from the image sensitivity.

(40) At least one of the color related information is a gradation conversion characteristic for the image signal. In this case, the chromaticness modulation control part is configured to obtain the gradation conversion characteristic and change the chromaticness modulation characteristic in accordance with the obtained gradation conversion characteristic.

Structuring the image processing apparatus in this way makes it possible to change the chromaticness modulation characteristic, dealing with the variations in the color representation which are inferred from the gradation conversion characteristic.

(41) An image processing program of the present invention causes a computer to function as the image processing part and the control part as described in the above (1).

(42) An image processing method of the present invention is an image processing method for performing an image processing on an image signal, the method comprising the step of obtaining an influential factor that influences a result of the image processing and controlling a level of the image processing in accordance with the obtained influential factor.

### BRIEF DESCRIPTION OF THE DRAWINGS

The nature, principle, and utility of the invention will become more apparent from the following detailed description when read in conjunction with the accompanying drawings in which like parts are designated by identical reference numbers, in which:

FIG. 1 is a schematic diagram for describing the structure of an electronic camera 11 (including an image processing apparatus).

FIG. 2 is a flow chart for describing the operation of color reproduction control part 24A.

FIG. 3 is a normalization table for color related information.

FIG. 4 is a schematic diagram showing a way of an adjustment of color reproduction according to a photometric contrast.

FIG. 5 is a schematic diagram showing a way of an adjustment of color reproduction according to hue and color occupancy.

FIG. 6 is a schematic diagram showing a way of an adjustment of color reproduction according to a color temperature.

FIG. 7 is a schematic diagram showing a way of an adjustment of color reproduction according to chromaticness.

FIG. 8 is a schematic diagram showing a way of an adjustment of color reproduction according to a photometric value.

FIG. 9 is a schematic diagram showing a way of an adjustment of color reproduction according to a shutter speed.

FIG. 10 is a schematic diagram showing a way of an adjustment of color reproduction according to image sensitivity.

FIG. 11 is a schematic diagram showing a way of an adjustment of color reproduction according to lens information.

FIG. 12 is a schematic diagram showing a way of an adjustment of color reproduction according to illumination information.

FIG. 13 is a flow chart for describing the operation of a gradation conversion control part 24B.

FIG. 14 is a schematic diagram showing a way of an adjustment of a gradation conversion characteristic according to a photometric contrast.

FIG. 15 is a schematic diagram showing a way of an adjustment of a gradation conversion characteristic according to hue.

FIG. 16 is a schematic diagram showing a way of an adjustment of a gradation conversion characteristic according to chromaticness.

FIG. 17 is a schematic diagram showing a way of an adjustment of a gradation conversion characteristic according to an MTF characteristic.

FIG. 18 is a schematic diagram showing a way of an adjustment of a gradation conversion characteristic according to a depth of focus.

FIG. 19 is a schematic diagram showing a way of an adjustment of a gradation conversion characteristic according to a photometry value.

FIG. 20 is a schematic diagram showing an example of a soft gradation conversion characteristic.

FIG. 21 is a schematic diagram showing an example of a hard gradation conversion characteristic.

FIG. 22 is a schematic diagram showing a way of an adjustment of a gradation conversion characteristic according to a color temperature.

FIG. 23 is a schematic diagram showing a way of an adjustment of a gradation conversion characteristic according to color occupancy.

FIG. 24 is a schematic diagram showing a way of an adjustment of a gradation conversion characteristic according to image sensitivity.

FIG. 25 is a schematic diagram showing a way of an adjustment of a gradation conversion characteristic according to a shutter speed.

FIG. 26 is a schematic diagram showing a way of an adjustment of a gradation conversion characteristic according to illumination information.

FIG. 27 is a flow chart for describing the operation of a noise suppression control part 24C.

FIG. 28 is a schematic diagram showing the relation between “image sensitivity” and “standard value of noise suppression”.

FIG. 29 is a schematic diagram showing a way of an adjustment of noise suppression according to a photometric contrast.

FIG. 30 is a schematic diagram showing an example of a soft gradation conversion characteristic.

FIG. 31 is a schematic diagram showing an example of a hard gradation conversion characteristic.

FIG. 32 is a schematic diagram showing a way of an adjustment of noise suppression according to a temperature.

FIG. 33 is a schematic diagram showing a way of an adjustment of noise suppression according to hue.

FIG. 34 is a schematic diagram showing a way of an adjustment of noise suppression according to chromaticness.

FIG. 35 is a schematic diagram showing a way of an adjustment of noise suppression according to color occupancy.

FIG. 36 is a schematic diagram showing a way of an adjustment of noise suppression according to a photometric value.

FIG. 37 is a schematic diagram showing a way of an adjustment of noise suppression according to a shutter speed.

FIG. 38 is a schematic diagram showing a way of an adjustment of noise suppression according to illumination information.

FIG. 39 is a schematic diagram showing a way of an adjustment of noise suppression according to a lens stop value.

FIG. 40 is a schematic diagram showing a way of an adjustment of noise suppression according to an MTF characteristic.

FIG. 41 is a schematic diagram showing a way of an adjustment of noise suppression according to a depth of focus.

FIG. 42 is a flow chart for describing the operation of a chromaticness modulation control part 24D.

FIG. 43 is a schematic diagram showing a way of an adjustment of a chromaticness modulation characteristic according to an adjustment value of color reproduction.

FIG. 44 is a schematic diagram showing a way of an adjustment of a chromaticness modulation characteristic according to a setting value of image sensitivity.

FIG. 45 is a schematic diagram showing an example of a soft gradation conversion characteristic.

FIG. 46 is a schematic diagram showing an example of a hard gradation conversion characteristic.

FIG. 47 is a schematic diagram showing a way of an adjustment of a chromaticness modulation characteristic according to a setting of a gradation conversion characteristic.

### DESCRIPTION OF THE PREFERRED EMBODIMENTS

Next, with reference to the accompanying drawings, embodiments of the present invention will be described.

[Description of Structure of Electronic Camera]

First of all, the structure of an electronic camera that is in common with each embodiment of the present invention will be described.

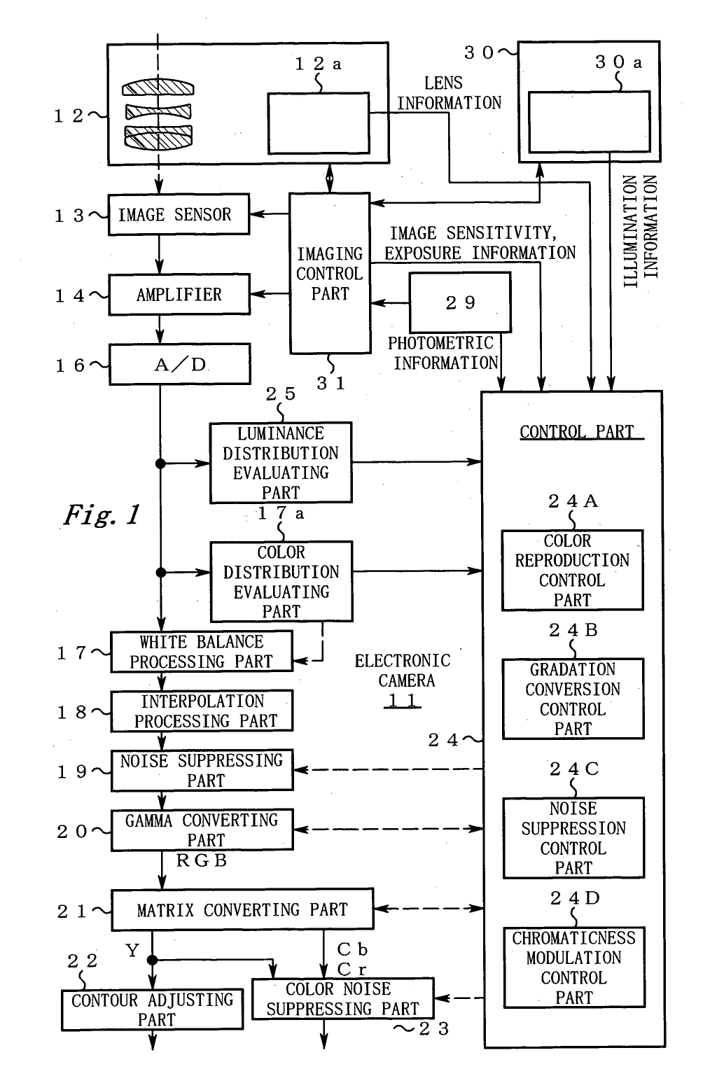

FIG. 1 is a schematic diagram for describing the structure of an electronic camera 11 (including an image processing apparatus). With reference to FIG. 1, the structure and outlined operation of the electronic camera 11 will be described.

In FIG. 1, a photographing lens 12 is attached to the electronic camera 11. The photographing lens 12 contains an in-lens MPU 12a. A light reception plane of an image sensor 13 is disposed on an image space side of the photographing lens 12 through a shutter mechanism (not shown).

An image signal that is output from the image sensor 13 is amplified by an amplifier 14. The amplified image signal is output to an A/D converting part 16. The amplification gain of the amplifier 14 is varied by setting the image sensitivity. The A/D converting part 16 digitizes the image signal pixel by pixel. The digitized image signal is output to a white balance processing part 17, a color distribution evaluating part 17a, and a luminance distribution evaluating part 25.

The color distribution evaluating part 17a evaluates the color distribution of the image signal and estimates the color temperature of a light source. The white balance processing part 17 adjusts the white balance of the image signal in accordance with the estimated value of the color temperature.

An interpolation processing part 18 performs a processing for interpolating periodically lost color components of the image signal that has been adjusted by the white balance processing part 17.

A noise suppressing part 19 performs a noise suppressing processing such as a local sum-of-product calculation for the image signal that has been interpolated.

A gamma converting part 20 performs a gradation conversion for the image signal that has been noise-suppressed and outputs the converted image signal to a matrix converting part 21.

The matrix converting part 21 converts the color coordinates of the image signal whose gradation has been converted into signal components YCbCr or the like. At that point, the matrix converting part 21 controls the converted gains of the color signal components CbCr for the entire screen so as to adjust the color reproduction of the entire screen. The converted gains of the color signal components (namely, adjustment values of color reproduction) are adjusted in compliance with rules of adjustment that will be described later.

The matrix converting part 21 outputs the luminance component Y to a contour adjusting part 22 and the color difference components CbCr whose color reproduction has been adjusted to a color noise suppressing part 23.

The contour adjusting part 22 performs a contour emphasizing processing for the luminance component Y with such as an unsharp mask.

On the other hand, the color noise suppressing part 23 varies the signal gains of the color difference components CbCr according to the following formulas.

Cb′=Cb·K(Y)/128

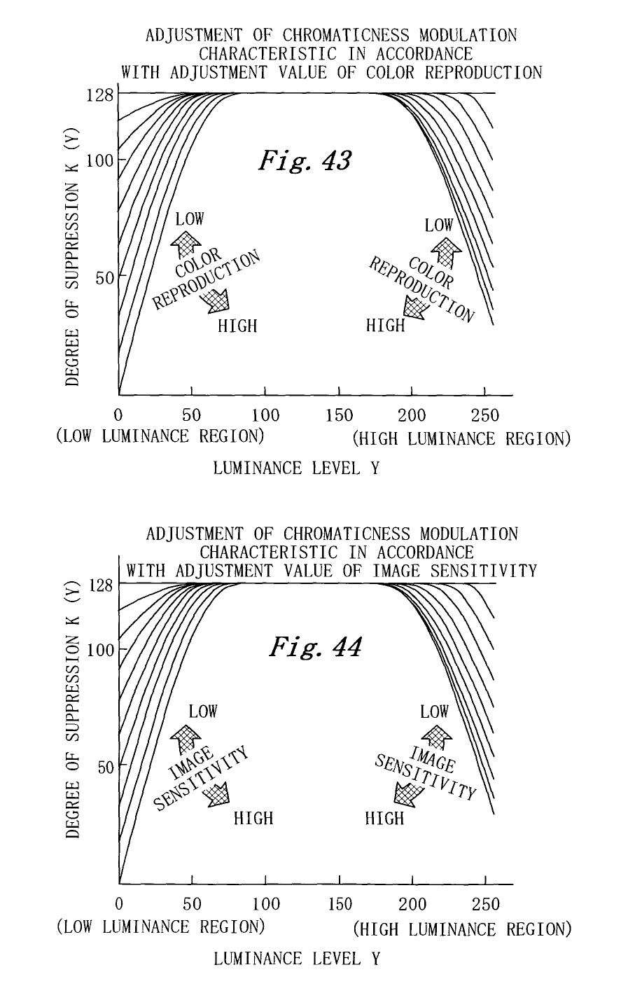

Cr′=Cr·K(Y)/128

where K (Y) is a value decided with reference to a function tale (see FIG. 43) that correlates the luminance component Y and the gain of the chromaticness level. In this process, it is possible to selectively suppress color noise that often occurs in the low luminance region and high luminance region of an image.

After completing such a sequence of signal processings, the electronic camera 11 performs a compressing processing, a recording/storing processing, and so forth for the image signal YCbCr.

Besides the forgoing structure for the signal processings, the electronic camera 11 further comprises a divided photometry sensor 29, a built-in or external flash device 30, and an imaging control part 31.

The divided photometry sensor 29 dividedly measures the light of the field in compliance with the TTL (Through The Lens) system or directly and outputs dividedly photometric values. Corresponding to the dividedly photometric values, the imaging control part 31 decides the exposure condition at capture of an image. In addition, the imaging control part 31 controls the stop value of the photographing lens 12, the shutter speed of the image sensor 13, the image sensitivity (gain) of the amplifier 14, and the flashing timing of the flash device 30, and so forth.

The electronic camera 11 further comprises a control part 24 as a feature structural element of the present invention. The control part 24 functions as a color reproduction control part 24A, a noise suppression control part 24B, a gradation conversion control part 24C, and a chromaticness modulation control part 24D.

[Relation Between Elements Set Forth in Claims and Elements Described in Embodiments of Present Invention]

Next, the relation between elements set forth in claims and elements described in embodiments of the present invention will be described. It should be noted that the relation is just an example, not limited to the present invention.

A photographing part set forth in claims corresponds to the photographing lens 12, the image device 13, the amplifier 14, and the imaging control part 31.

A control part set forth in claims corresponds to the control part 24.

An image processing part set forth in claims corresponds to the matrix converting part 21, the gamma converting part 20, the noise suppressing part 19, the color noise suppressing part 23, and so forth.

A color reproduction adjusting part set forth in claims corresponds to “function for varying converted gains of color difference components CbCr”.

A color reproduction control part set forth in claims corresponds to the color reproduction control part 24A.

A gradation converting part set forth in claims corresponds to the gamma converting part 20.

A gradation conversion control part set forth in claims corresponds to the gradation conversion control part 24B.

A noise suppressing part as set forth in claims corresponds to the noise suppressing part 19.

A noise suppression control part as set forth in claims corresponds to the noise suppression control part 24C.

A chromaticness modulation control part set forth in claims corresponds to the chromaticness modulation control part 24D.

A chromaticness modulating part set forth in claims corresponds to the “function for varying the gains of the color difference components CbCr corresponding to the luminance level”.

[Description of Operation of Color Reproduction Control Part 24A]

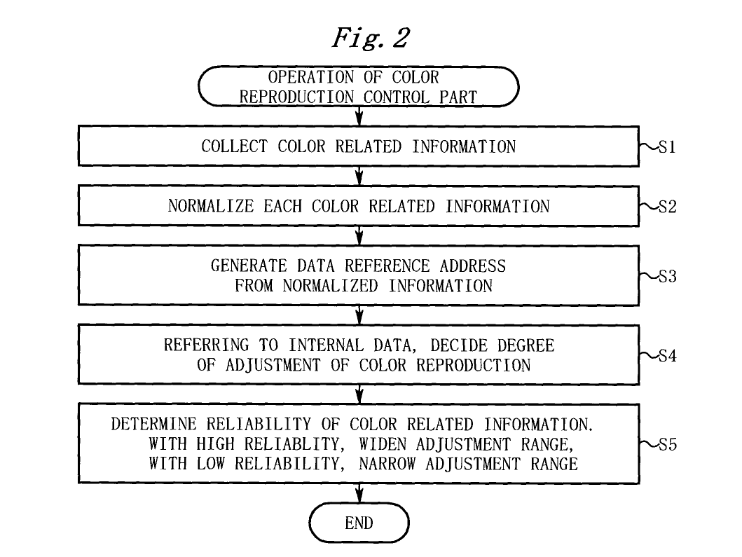

FIG. 2 is a flow chart for describing the operation of the color reproduction control part 24A. Next, in the order of step numbers shown in FIG. 2, the operation of the color reproduction control part 24A will be described.

Step 1: The color reproduction control part 24A obtains color related information that influences the color representation of an image signal to be processed.

The “color representation” here refers to how a color of an image signal appears on display or when printed. The “color representation” is for example brightness or clarity of a color, dullness of a color, eccentricity of hue, tone of a color (high key, low key, warm tone, cool tone, and so forth), representation of the difference in subtle colors, representation of a color of a plane portion, representation of a color of edges, representation of a color of details, representation of a color of a dark portion, representation of a color of a highlighted portion, a color deviation, an unnatural color, color noise, and so forth.

The color reproduction control part 24A collects the following color related information, for example.

(A) a photometric value (divided photometric values) of the divided photometry sensor 29,

(B) illumination information transferred from the MPU 30a of the flash device,

(C) an exposure condition transferred from the imaging control part 31,

(D) lens information transferred from the in-lens MPU 12a,

(E) image sensitivity transferred from the imaging control part 31,

(F) color information (for example, a color temperature of a light source, a hue angle, chrominance, and so forth) transferred from the color distribution evaluating part 17a, and

(G) a color occupancy (a value that represents the screen occupancy of a color) transferred from the color distribution evaluating part 17a.

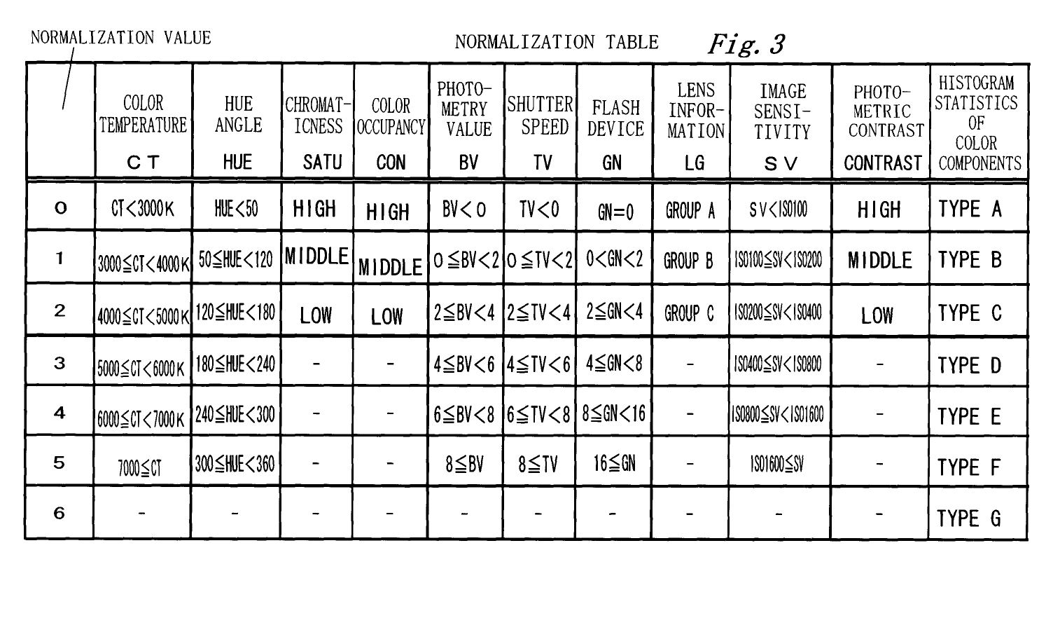

Step 2: The color reproduction control part 24A normalizes each piece of the color related information with reference to a normalization table shown in FIG. 3.

Proper normalizing increments largely vary in accordance with the characteristic of the image sensor 13 in use. Thus, it is preferable to perform a photographing test of the electronic camera 11 and obtain how much each piece of color related information affects the color representation. Then, based on the test results, for more influential color related information, by smaller increments normalization of the color related information is performed.

Step S3: The color reproduction control part 24A combines the normalized values of individual pieces of the color related information and generates an unique data reference address. The data reference address corresponds to an address of an internal data area of the color reproduction control part 24A. In the internal data area, matrix coefficient data corresponding to each combination of normalized values is stored in compliance with a rule that will be described later.

Step S4: The color reproduction control part 24A references the internal data area corresponding to the data reference address and obtains a matrix coefficient of a color coordinate conversion matrix.

Step S5: The color reproduction control part 24A determines the reliability of the color related information. The reliability represents the degree of how reliably the result of the image processing can be inferred from the color related information. For example, it is preferred to determine the reliability depending on the occurrence frequency or fluctuation of the color related information. In addition, it is preferred to determine the reliability depending on how much the color related information affects the entire image signal.

As the color reproduction control part 24A obtains a higher reliability, it causes the matrix coefficient of the color coordinate conversion matrix to be further apart from the standard value so as to widen the adjustment range of the color reproduction. In contrast, as it obtains a lower reliability, the color reproduction control part 24A causes the matrix coefficient of the color coordinate conversion matrix to approach the standard value so as to narrow the adjustment range of the color reproduction.

In such an operation, with highly reliable color related information, the adjustment range of the color reproduction can be widened, which realizes a more effective image processing. In contrast, with not reliable color related information, the adjustment range of the color reproduction can be narrowed, which can prevent the image processing from excessively varying. Consequently, the image processing can be prevented from failing.

The color reproduction control part 24A transfers the obtained matrix coefficient to the matrix converting part 21. Using the matrix coefficient, the matrix converting part 21 executes the color coordinate conversion for the image signal. (At that point, with the matrix coefficient, the conversion gains of the signal components CbCr are varied. As a result, the color reproduction of the entire image is adjusted.)

[Adjustment of Color Reproduction]

An optimum adjustment value of the color reproduction largely fluctuates depending on the dynamic range and noise characteristic of the image sensor 13 used in each electronic camera. Thus, instead of providing real adjustment values of individual electronic cameras, the Specification describes a substantial adjustment of color reproduction in detail.

Those in the art can in reality implement the embodiment by varying the pre-designated standard matrix coefficient (hereinafter referred to as “standard value”) according to the adjustment that will be described in the following.

(1) Adjustment of Color Reproduction According To Photometric Contrast

The color reproduction control part 24A obtains divided photometric values from the divided photometry sensor 29. The divided photometric values are values of which the field is dividedly measured. The color reproduction control part 24A calculates the difference between bright and dark levels of the divided photometric values (or the ratio thereof) so as to obtain the photometric contrast of the field.

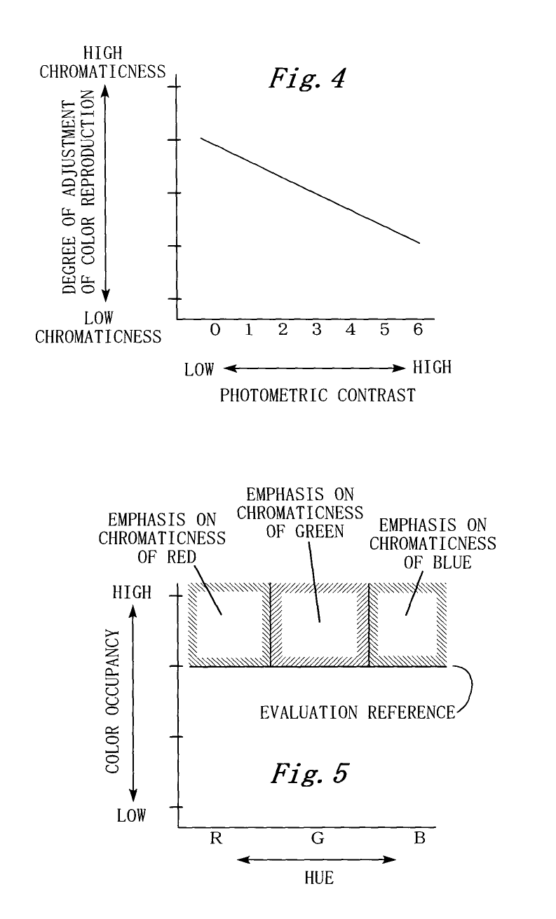

FIG. 4 is a schematic diagram showing a way of an adjustment of color reproduction corresponding to the photometric contrast.

Normally, the higher the photometric contrast is, the larger the variation in color signal components of an image signal is. As a result, it is likely that a color is saturated. Thus, as shown in FIG. 4, as the photometric contrast heightens, the color reproduction control part 24A controls the degree of the adjustment of the chromaticness to be lower than the standard value. As a result, when the photometric contrast is higher than usual, the chromaticness is not excessively emphasized. Thus, the saturation of a color is suppressed. Consequently, since the loss of color information due to the color saturation is suppressed, subtle color differences can be accurately maintained.

In contrast, when the photometric contrast is low, the variation in the brightness of the image signal is small. Thus, the variation in a color looks sober. Thus, as shown in FIG. 4, as the photometric contrast is lowered, the color reproduction control part 24A controls the degree of the adjustment of the chromaticness to be higher than the standard value. As a result, when the photometric contrast is lower than normal, the chromaticness is properly emphasized. Thus, an image signal with clear chromaticness can be obtained.

The reliability of the photometric contrast can be determined depending on the percentage of which the photometric contrast matches with the area of the image (occupation rate). For example, when the value of the photometric contrast is almost constant on the entire screen, the photometric contrast is highly reliable. In contrast, when the value of the photometric contrast largely deviates on the entire screen, the reliability is low. It is preferred to adjust the level range of the color reproducibility using such reliability.

(2) Adjustment of Color Reproduction According To Hue and Color Occupancy

The color reproduction control part 24A obtains color distribution information on an image signal from the color distribution evaluating part 17a. The color reproduction control part 24A analyzes the hue and color occupancy of the image signal according to the color distribution information.

In this case, the “hue” refers to hue of the main range of an image (for example, the center portion of the screen, the AF selection area, or the like), hue which frequently appears on the entire screen, hue of a large area in the image, an average value of hue of the entire image, or the like. The “color occupancy” represents the screen occupancy of a color of the image signal.

For example, statistically processing hue components of the image signal for histogram statistics of the hue is an easy and preferable method for analyzing the hue and color occupancy. In this case, it is able to obtain hue which appears at high frequency and the occurrence frequency of every hue (equivalent to color occupancy) together.

FIG. 5 is a schematic diagram showing a way of an adjustment of color reproduction according to hue and color occupancy.

In other words, upon determining that the color occupancy of hue of the red region is higher than the evaluation reference, the color reproduction control part 24A sets the chromaticness emphasis on red to a higher value than the standard value. In this case, the main red region (such as a sunset or a red flower) of the image signal can be brightly emphasized.

Upon determining that the color occupancy of hue of the green region is higher than the evaluation reference, the color reproduction control part 24A sets the chromaticness emphasis on green to a higher value than the standard value. In this case, the main green region (a glassy plain or trees and plants) of the image signal can be brightly emphasized as deep green.

In addition, upon determining that the color occupancy of hue of the blue region is higher than the evaluation reference, the color reproduction control part 24A sets the chromaticness emphasis on blue to a higher value than the standard value. In this case, the main blue region (such as a blue sky) of the image signal can be brightly emphasized.

In this case, the color occupancy corresponds to the occupation rate or influence rate of hue and represents the reliability of hue.

(3) Adjustment of Color Reproduction According To Color Temperature

The color reproduction control part 24A obtains information on a color temperature (estimated value) of the light source as a judgment material for adjusting the white balance from the color distribution evaluating part 17a. The color temperature may be estimated from white that is set by the user in a preset white balance rather than the image signal obtained as the judgment material. Alternatively, the color temperature may be estimated from a manual setting value of the white balance.

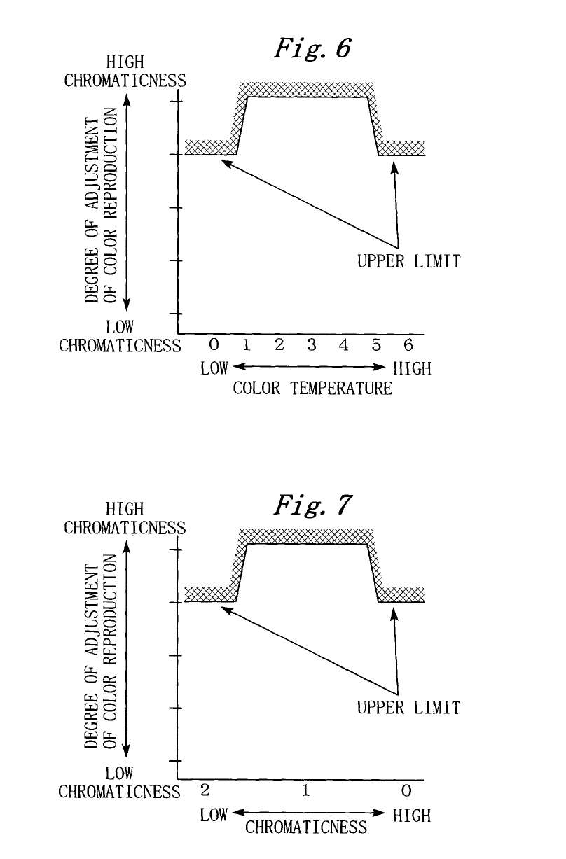

FIG. 6 is a schematic diagram showing a way of an adjustment of color reproduction according to the color temperature.

When the color temperature at capture of an image signal deviates from the standard range as expected with the color filter array of the image sensor 13, the differences among levels of signal components (RGB components) that are output from the image sensor 13 becomes large. In this case, since the exposure condition is decided within the range that the largest signal component is not saturated, the signal level of the smallest signal component is lowered. As a result, the S/N rate deteriorates. Thus, when the chromaticness is excessively emphasized in such a state, the S/N ratio of the image signal decreases.

Thus, as shown in FIG. 6, when the color temperature of the light source deviates from the standard range and goes down, the control part 24 designates an upper limit of the emphasis on the chromaticness so that the chromaticness of blue does not go excessively high. As a result, even if the chromaticness is emphasized due to another factor, the chromaticness (especially, blue) is not excessively emphasized.

In contrast, as shown in FIG. 6, when the color temperature of the light source is higher beyond the standard range, the color reproduction control part 24A designates an upper limit of the emphasis of the chromaticness so that the chromaticness of red does not go excessively high. As a result, even if the chromaticness is emphasized due to another factor, the chromaticness (especially, red) is not excessively emphasized.

When the color reproduction is adjusted according to the color temperature, the obstruction of noise in the image signal can be suppressed.

The “deviation of color temperature from standard range” represents the reliability of the color temperature. As the reliability of the color temperature, the deviation rate (namely, the occupation rate or influence rate) of the color temperature in the entire image may be used. It is preferred to adjust the level range of the color reproduction using such reliability.

(4) Adjustment of Color Reproduction According To Chromaticness

The color reproduction control part 24A obtains color distribution information on an image signal from the color distribution evaluating part 17a. The color reproduction control part 24A analyzes the chromaticness of the image signal according to the color distribution information.

In this case, the “chromaticness” is preferably the main range (the center portion of the screen, the AF selection area, or the like) of the image, the chromaticness that frequently occurs on the screen, the chromaticness of a large area part of the image, an average value of the chromaticness of the entire image, or the like.

FIG. 7 is a schematic diagram showing a way of an adjustment of color reproduction according to the chromaticness.

In an image signal of a monochrome image, an image signal of a high key representation, or an image signal of a low key representation, the chromaticness is generally low. If the image signal with low chromaticness is simply emphasized, the resultant image signal is different from the image which the user intends to create. Alternatively, an unnecessary color may be added. Thus, as shown in FIG. 7, when the chromaticness of the image signal is lower than the standard range, the color reproduction control part 24A designates an upper limit to the emphasis on the chromaticness so as to prevent the emphasis of the chromaticness from exceeding the upper limit.

On the other hand, the chromaticness of an image signal of a bright object is high. If the image signal with high chromaticness is simply emphasized, the color thereof will be saturated. Thus, as shown in FIG. 7, when the chromaticness of the image signal is higher than the standard range, the color reproduction control part 24A designates an upper limit of the emphasis on the chromaticness so that the emphasis of the chromaticness does not exceed the upper limit.

As the reliability of the chromaticness, the occurrence frequency of the chromaticness on the screen, the fluctuation of the chromaticness, or the like can be used. It is preferred to adjust the level range of the color reproduction using such reliability.

(5) Adjustment of Color Reproduction According To Photometric Value

The color reproduction control part 24A obtains divided photometric values from the divided photometry sensor 29. The color reproduction control part 24A obtains a photometric value according to the divided photometric values.

In this case, the “photometric value” is preferably a photometric value of the main range (the center portion of the screen, the AF selection area, or the like) of the image, the minimum, maximum, or medium value of the divided photometric values, a photometric value of a large area part of the image, an average value of the divided photometric values of the entire image, or the like.

FIG. 8 is a schematic diagram showing a way of an adjustment of color reproduction according to the photometric value.

When the photometric value is excessively low, the S/N ratio of an image signal deteriorates. In this case, when the chromaticness is excessively emphasized, noise in the image signal excessively gets obstructive.

Thus, as shown in FIG. 8, when the photometric value is lower than the standard range, the color reproduction control part 24A designates an upper limit of the emphasis of the chromaticness so that the emphasis of the chromaticness does not exceed the upper limit.

By adjusting the color reproduction according to the photometric value, the obstruction of noise in the image signal can be suppressed.

As the reliability of the photometric value, the frequency of the photometric value on the screen, the fluctuation of the photometric value on the screen, the chronological fluctuation of the photometric value, or the like can be used. It is preferred to adjust the level range of the color reproduction using such reliability.

(6) Adjustment of Color Reproduction According To Shutter Speed

The color reproduction control part 24A obtains an exposure condition from the imaging control part 31. The color reproduction control part 24A obtains a shutter speed according to the exposure condition.

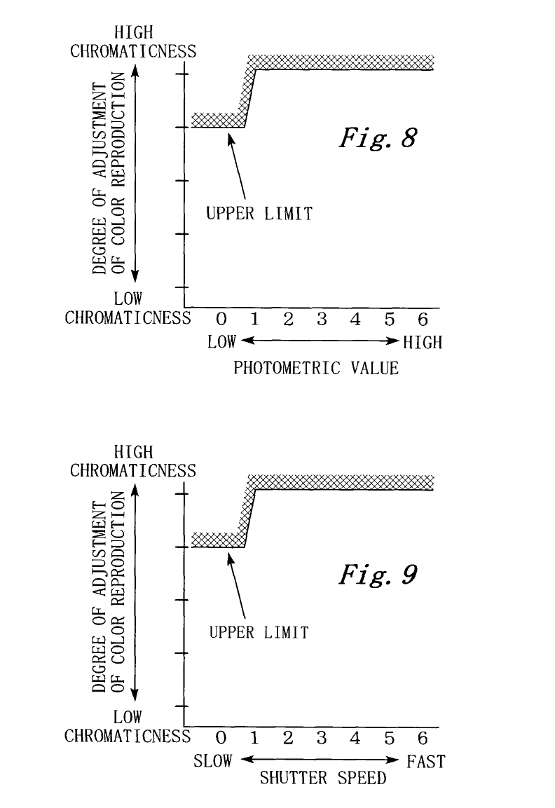

FIG. 9 is a schematic diagram showing a way of an adjustment of color reproduction according to the shutter speed.

With a slow shutter speed upon night photographing, noise due to a long time exposure tends to occur. If the chromaticness is excessively emphasized here, color noise in the image signal becomes obstructive.

Thus, as shown in FIG. 9, when the shutter speed decreases to a value smaller than the standard range, the color reproduction control part 24A designates an upper limit of the emphasis of the chromaticness so that the emphasis of the chromaticness does not exceed the upper limit.

By adjusting the color reproduction according to the shutter speed, the obstruction of noise in the image signal can be suppressed.

(7) Adjustment of Color Reproduction According To Image Sensitivity The color reproduction control part 24A obtains a setting of image sensitivity of the image sensor 13 (for example, a gain setting of the amplifier 14) from the imaging control part 31.

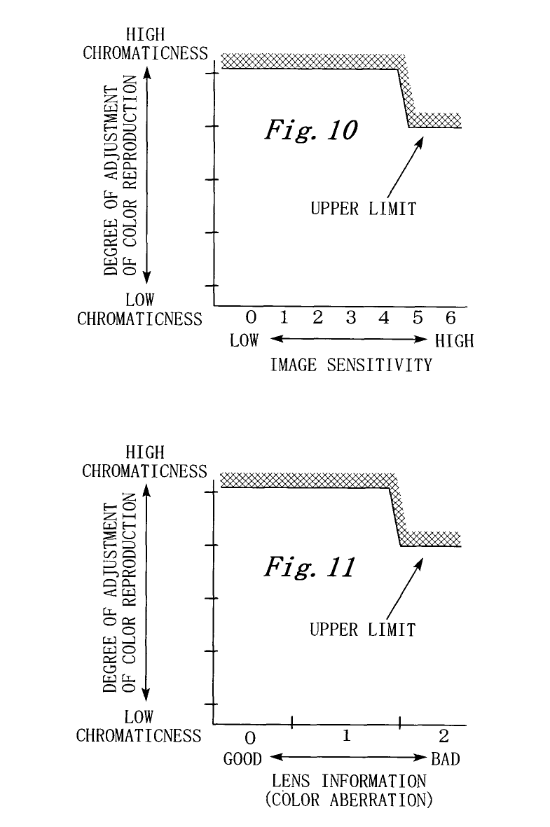

FIG. 10 is a schematic diagram showing a way of an adjustment of color reproduction according to the image sensitivity.

As the image sensitivity increases, the S/N ratio of the image signal further deteriorates. If the chromaticness is excessively emphasized here, color noise in the image signal becomes obstructive.

Thus, as shown in FIG. 10, when the image sensibility increases to a value larger than the standard range, the color reproduction control part 24A designates an upper limit of the emphasis of the chromaticness so as not to exceed the upper limit.

By adjusting the color reproduction according to the image sensitivity, the obstruction of the noise in the image signal can be suppressed.

(8) Adjustment of Color Reproduction According To Lens Information

The color reproduction control part 24A obtains lens information on the photographing lens 12 from the in-lens MPU 12a.

The lens information is preferably a focus distance of the photographing lens 12, an aberration characteristic, a distance to an in-focus position, a stop value at capture of an image, or the like. The color reproduction control part 24A evaluates and determines the degree of a color aberration (an axial color aberration, a magnification color aberration, or the like) of the image signal according to such information.

FIG. 11 is a schematic diagram showing a way of an adjustment of color reproduction according to the lens information (color aberration).

When the chromaticness is excessively emphasized in an imaging condition that the color aberration deteriorates, the color aberration of the image signal becomes obstructive.

Thus, as shown in FIG. 1, in the condition that the color aberration deteriorates from the standard range, the color reproduction control part 24A designates an upper limit of the emphasis of the chromaticness so that the emphasis of the chromaticness does not exceed the upper limit.

By adjusting the color reproduction according to the lens information, the obstruction of the color aberration of the image signal can be suppressed.

As the reliability of the aberration characteristic, a stop value at capture of image, a photographing distance, or the like can be used. With the reliability, the degree of how much the aberration characteristic obtained from the lens information matches with the aberration characteristic at capture of image can be estimated. It is preferred to adjust the level range of the color reproduction using such reliability.

(9) Adjustment of Color Reproduction According To Illumination Information

The color reproduction control part 24A obtains illumination information from the MPU 30a of the flash device 30.

The illumination information is preferably the presence/absence of the flashing, the flash GN (flash light amount) , or the like.

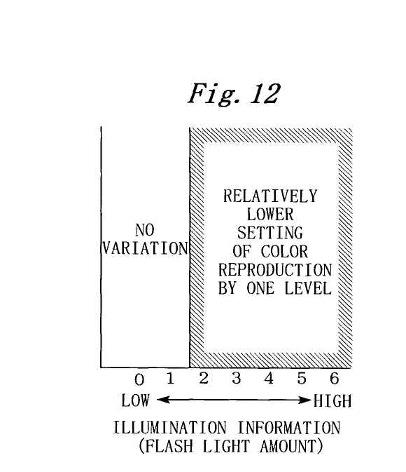

FIG. 12 is a schematic diagram showing a way of an adjustment of color reproduction according to the illumination information (in this example, the flash light amount).

When the flash light amount increases to some extent, the difference between a lighted portion and a non-lighted portion will be large. In this situation, if the chromaticness is excessively emphasized, it is likely that a color is saturated in an image signal.

Thus, as shown in FIG. 12, with a large flash light amount, the color reproduction control part 24A relatively decreases the adjustment value of the chromaticness. For example, it is preferred to lower the adjustment value by one level.

By adjusting the color reproduction according to the illumination information, the color saturation can be suppressed. As a result, an image signal with natural and subtle tone can be obtained.

The reliability of the illumination information is preferably the distance to the object. As the distance to the object increases, the degree at which the illumination affects the entire screen (namely, the degree of the influence) decreases. Thus, the reliability of the illumination information is lowered. It is preferred to adjust the level range of the color reproduction in accordance with the reliability.

[Description of Operation of Gradation Conversion Control Part 24B]

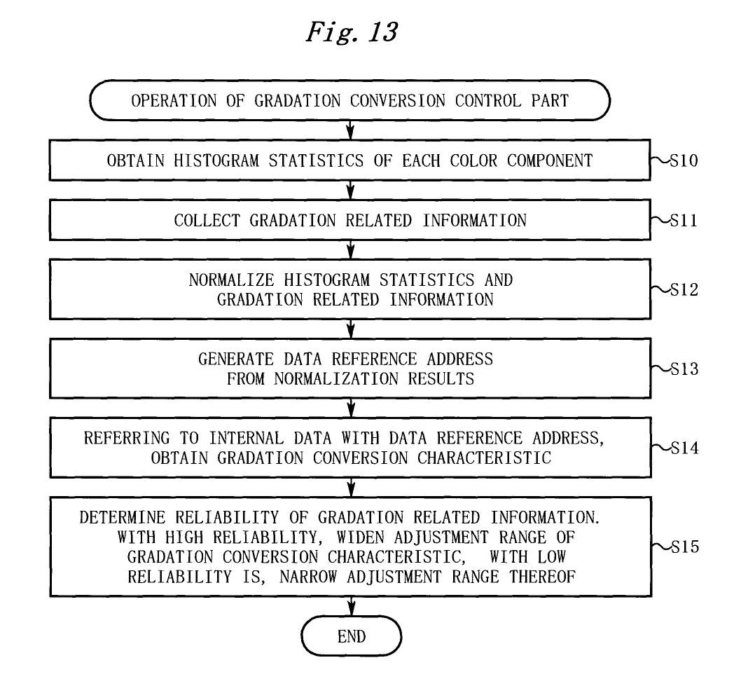

FIG. 13 is a flow chart for describing the operation of the gradation conversion control part 24B. Next, in the order of step numbers shown in FIG. 13, the operation of the gradation conversion control part 24B will be described.

Step S10: The gradation conversion control part 24B obtains information on histogram statistics of each color component from the luminance distribution evaluating part 25.

Step S11: The gradation conversion control part 24B obtains gradation related information that influences the gradation representation of an image signal.

The “gradation representation” means representation of gradation of an image signal that is displayed or printed. The “gradation representation” is for example brightness or clarity of gradation, eccentricity of gradation, tone of gradation (high key, low key, warm tone, cool tone, and so forth), representation of the difference in subtle gradation, representation of gradation of a plane portion, representation of gradation of edges, representation of gradation of details, representation of gradation of a dark portion, representation of gradation of a highlighted portion, a gradation deviation, noise, and so forth.

The gradation conversion control part 24B collects for example the following gradation related information.

(A) a photometric value (divided photometric values) of the divided photometry sensor 29,

(B) illumination information transferred from the MPU 30a of the flash device,

(C) an exposure condition transferred from the imaging control part 31,

(D) lens information transferred from the in-lens MPU 12a,

(E) image sensitivity transferred from the imaging control part 31,

(F) color information (for example, a color temperature of a light source, a hue angle, chrominance, and so forth) transferred from the color distribution evaluating part 17a, and

(G) a color occupancy (a value that represents a screen occupancy of a color) transferred from the color distribution evaluating part 17a.

Step 12: The gradation conversion control part 24B normalizes (groups) the histogram statistics and the gradation related information according to the normalization table shown in FIG. 3.

Proper normalizing steps largely vary according to the characteristic of the image sensor 13 for use. Thus, it is preferred to perform a photographing experiment of the electronic camera 11, obtain the influence of the gradation related information against the gradation representation, and normalize pieces of the gradation related information that more influence the gradation representation at smaller steps.

Step S13: The gradation conversion control part 24B combines normalization values of individual pieces of gradation related information and generates unique data reference addresses. The data reference addresses correspond to addresses of the internal data area of the gradation conversion control part 24B. In the internal data area, guide numbers of gradation conversion characteristics according to a way of an adjustment that will be described later are correlated with combinations of the normalization values.

Step S14: The gradation conversion control part 24B references the internal data area according to the data reference address and obtains an guide number of the gradation conversion characteristic.

Step S15: The gradation conversion control part 24B determines the reliability of the gradation related information. In this case, the reliability represents the degree of how much the result of the image processing can be accurately estimated in accordance with the gradation related information. For example, it is preferred to determine the reliability with the occupation rate of the area that matches with the gradation related information in the entire image signal. In addition, it is preferred to determine the reliability in accordance with of the influence of how much the gradation related information is influenced to the entire image signal.

As the reliability heightens, the gradation conversion control part 24B causes the guide number of the gradation conversion characteristic to be apart from the standard value, widening the adjustment range of the gradation conversion characteristic. In contrast, as the reliability lowers, the gradation conversion control part 24B causes the guide number to approach the standard value so as to narrow the adjustment range of the gradation conversion characteristic.

In this operation, according to highly reliable gradation related information, the adjustment range of the gradation conversion can be widened, which achieves a much more effective image processing. In contrast, when the adjustment range of the gradation conversion is narrowed according to not so reliable gradation related information, the image processing can be prevented from excessively varying. As a result, the image processing can be prevented from failing.

The gradation conversion control part 24B transfers the obtained guide number to the gamma converting part 20. The gamma converting part 20 selects a function table of the gradation conversion characteristic according to the guide number.

[Adjustment of Gradation Conversion Characteristic]

An optimum adjustment value of the gradation conversion characteristic largely fluctuates depending on the dynamic range and noise characteristic of the image sensor 13 used in each electronic camera. Thus, instead of providing real adjustment values of individual electronic cameras, the Specification describes an intrinsic way of adjustment of gradation conversion characteristic in detail.

First of all, those in the art sets forth the gradation conversion characteristic (hereinafter referred to as “standard characteristic”) with the histogram statistics of each color component. Next, they vary the standard characteristic according to a way of an adjustment that will be described in the following. In these procedures, the embodiment can be actually implemented.

(1) Adjustment of Gradation Conversion Characteristic According To Photometric Contrast

The gradation conversion control part 24B obtains divided photometric values from the divided photometry sensor 29. The divided photometric values are values of which the field is dividedly measured. The gradation conversion control part 24B obtains the difference between bright and dark levels (or the ratio thereof) of the divided photometric values. As a result, the gradation conversion control part 24B obtains the photometric contrast of the field.

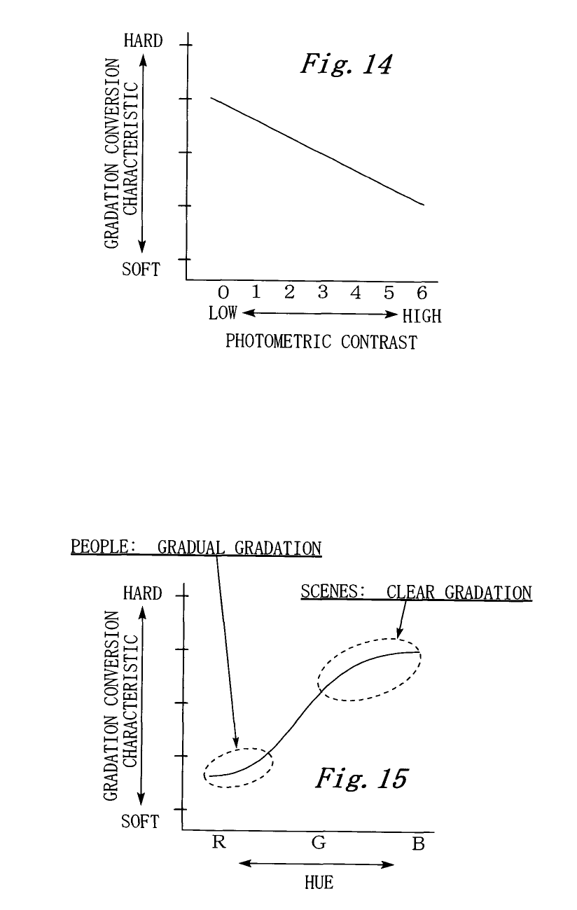

FIG. 14 shows a way of an adjustment of the gradation conversion characteristic according to the photometric contrast.

Normally, the higher the photometric contrast becomes, the larger the variation in the image signal becomes. As a result, it is likely that the image signal will be stark white or blacken out. Thus, as shown in FIG. 14, as the photometric contrast heightens, the gradation conversion control part 24B shifts the gradation conversion characteristic to the softer gradation side than the standard characteristic. As a result, an image signal with less whiteness or blacken-out can be obtained.

In contrast, when the photometric contrast is low, the variation in the brightness of an image signal is small. As a result, the variation in the gradation appears to be small. Thus, as shown in FIG. 14, as the photometric contrast lowers, the gradation conversion control part 24B shifts the gradation conversion characteristic to the harder gradation side than the standard characteristic. As a result, the gradation contrast of the image signal is properly emphasized. Thus, an image signal of clear gradation can be obtained.

The reliability of the photometric contrast can be determined depending on how many percentage of the image area matches with the photometric contrast (occupation ratio). For example, when the values of photometric contrast are almost uniform on the entire screen, the reliability is high. In contrast, when the values of photometric contrast largely deviate on the entire screen, the reliability is low. It is preferred to adjust the level range of the gradation conversion characteristic using such reliability.

The gradation conversion control part 24B obtains color distribution information on an image signal from the color distribution evaluating part 17a. According to the color distribution information, the gradation conversion control part 24B analyzes hue of the image signal.

In this case, the “hue” is hue of the main range (the center portion of the screen, the AF selection area, or the like) of the image, hue with high occurrence frequency on the entire screen, hue of a large area of the image, an average value of hue of the entire image, or the like.

As an easy method for analyzing hue, it is preferred to perform a statistic process for a hue component of an image signal and take histogram statistics of the hue.

FIG. 15 is a schematic diagram showing a way of an adjustment of the gradation conversion characteristic according to the hue.

In other words, when the gradation conversion control part 24B has determined that the hue of the image signal is reddish, the gradation conversion control part 24B shifts the gradation conversion characteristic to the softer gradation side than the standard characteristic. In this operation, a skin color part of a portrait or the like can be represented with gentle gradation.

When the gradation conversion control part 24B has determined that the hue of the image signal is green or blue, the gradation conversion control part 24B shifts the gradation conversion characteristic to the harder gradation side than the standard characteristic. In this operation, a scene that mainly contains green and blue can be represented with clear gradation.

As the reliability of the hue, the color occupancy, the fluctuation of the hue, or the like can be used. It is preferred to adjust the level range of the gradation conversion characteristic using such reliability.

(3) Adjustment of Gradation Conversion Characteristic According to Chromaticness

The gradation conversion control part 24B obtains color distribution information on an image signal from the color distribution evaluating part 17a. According to the color distribution information, the gradation conversion control part 24B analyzes the chromaticness of the image signal.

In this case, the “chromaticness” is preferably chromaticness of the main range (the center portion of the screen, the AF selection area, or the like) of the image, chromaticness that frequently occurs on the screen, chromaticness of a large area portion of the image, an average value of chromaticness of the entire image, or the like. As an easy method for analyzing chromaticness, it is preferred to take histogram statistics of chromaticness of the image signal.

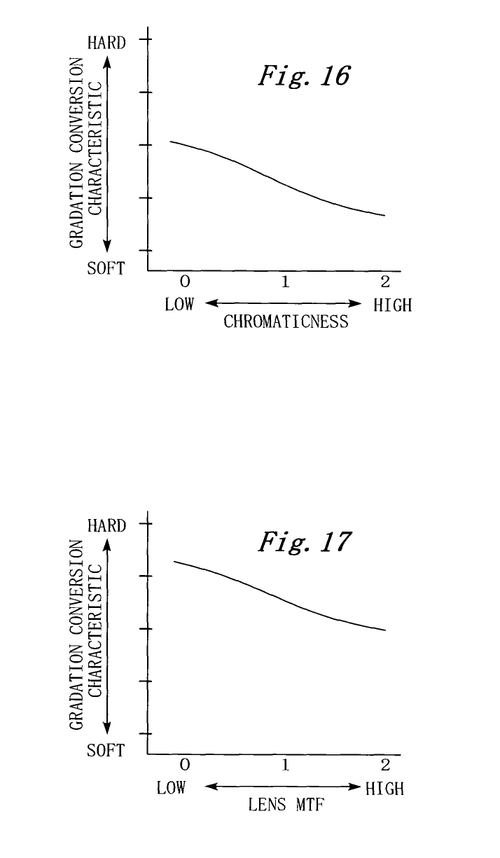

FIG. 16 is a schematic diagram showing a way of an adjustment of the gradation conversion characteristic according to the chromaticness.

An image signal of a bright object has a high chromaticness. A color of the image signal of high chromaticness tends to be saturated if the gradation contrast thereof is simply emphasized. Thus, as shown in FIG. 16, the gradation conversion control part 24B shifts the gradation conversion characteristic to the softer gradation side than the standard characteristic when the chromaticness of the image signal is higher beyond the standard range. As a result, an image signal with suppressed color saturation can be obtained.

In contrast, an image signal of low chromaticness close to a monochrome image does not have a remarkable color variation, therefore, it appears not to have abundant gradation variation. Thus, as shown in FIG. 16, when the chromaticness of the image signal does not reach the standard range, the gradation conversion control part 24B shifts the gradation change characteristic to the harder gradation side than the standard characteristic. In this case, an image signal with its small color variation compensated by a large gradation variation can be obtained.

Note that an image signal with low or high key representation tends to have low chromaticness. In case where the gradation contrast of such an image signal is simply increased, there may arise a problem that the resultant is a different image from what the user intends to capture, or that it has unwanted colors. To prevent these problems, it is preferred that the gradation conversion control part 24B should shift the gradation conversion characteristic to be lower than the standard characteristic when the chromaticness of the image signal does not reach the standard range.

As the reliability of the chromaticness, the occurrence frequency of chromaticness on the screen, the fluctuation of chromaticness, or the like can be used. With such reliability, it is preferred to adjust the level range of the gradation conversion characteristic.

(4) Adjustment of Gradation Conversion Characteristic According To MTF Characteristic of Lens

The gradation conversion control part 24B obtains an MTF (Modulation Transfer Function) characteristic at capture of an image signal as one piece of lens information from the in-lens MPU 12a.

FIG. 17 is a schematic diagram showing a way of an adjustment of the gradation conversion characteristic according to the MTF characteristic.

When the MTF characteristic is lower than the standard, the edges of an image signal are likely to gradually vary. Thus, upon determining that the MTF characteristic is lower than the standard, the gradation conversion control part 24B sets the gradation conversion characteristic to a higher gradation value than the standard characteristic so as to emphasize the gradation contrast.

As the reliability of the MTF characteristic, a stop value at capture of image, a distance to an object, or the like can be used. With such reliability, the degree of how much the MTF characteristic obtained from the lens information matches with the MTF characteristic at capture of image can be estimated. It is preferred to adjust the level range of the gradation conversion characteristic using such reliability.

(5) Adjustment of Gradation Conversion Characteristic According to Depth of Focus of Lens

The gradation conversion control part 24B obtains a depth of focus at capture of an image signal as one piece of lens information from the in-lens MPU 12a.

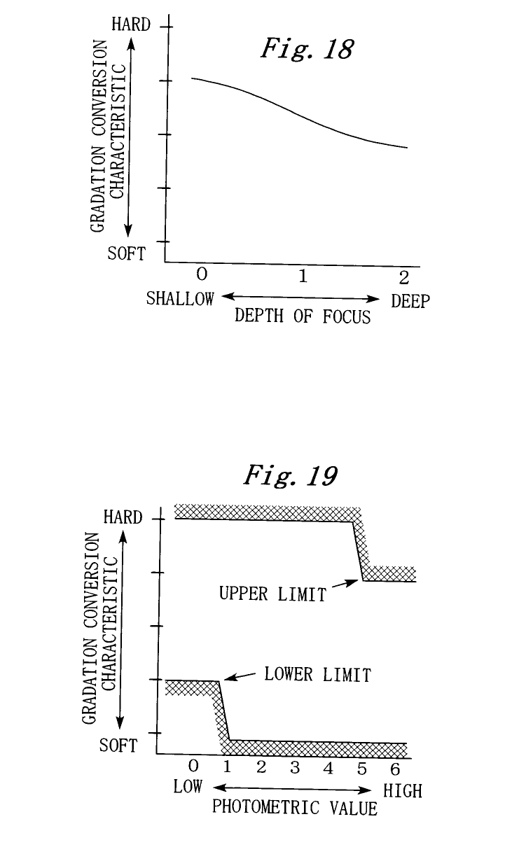

FIG. 18 is a schematic diagram showing a way of an adjustment of the gradation conversion characteristic according to the depth of focus.

When the depth of focus gets shallower than the standard, large unsharp portions appear before and after the in-focus position. At that point, when the contrast at the in-focus position is low, the gradation of the image signal is soft. Thus, when the gradation conversion control part 24B has determined that the depth of focus is shallower than the standard, the gradation conversion control part 24B shifts the gradation conversion characteristic to the harder gradation side than the standard characteristic as shown in FIG. 18. As a result, the gradation contrast at the in-focus position is emphasized against the large unsharp portions before and after that. Thus, an image signal of good visibility can be obtained.

(6) Adjustment of Gradation Conversion Characteristic According to Photometric Value

The gradation conversion control part 24B obtains divided photometric values from the divided photometry sensor 29. The gradation conversion control part 24B obtains a photometric value according to the divided photometric values.

in this case, the “photometric value” is preferably a photometric value of the main range (the center portion of the screen, the AF selection area, or the like) of the image, the minimum, maximum, or medium value of the divided photometric values, a photometric value of a large area portion of the image, an average value of the divided photometric values of the entire image, or the like.

FIG. 19 is a schematic diagram showing a way of an adjustment of the gradation conversion characteristic according to the photometric value.

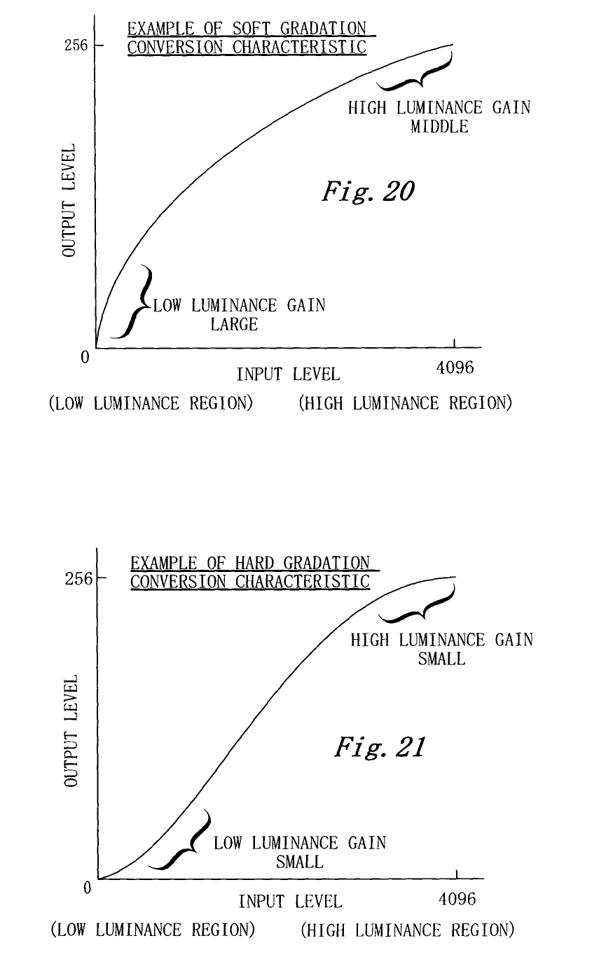

When the photometric value is very low, the S/N ratio of the low luminance region of an image signal deteriorates. With a soft gradation conversion characteristic shown in FIG. 20 set, noise in the low luminance region is excessively amplified due to large low luminance gain. In contrast, with a hard gradation conversion characteristic shown in FIG. 21 set, the low luminance gain decreases, which consequently suppresses noise in the low luminance region.

Thus, as shown in FIG. 19, when the photometric value is very low, the gradation conversion control part 24B designates a soft gradation limit of the gradation conversion characteristic. As a result, since the low luminance gain is not excessively large, the obstruction of noise in the low luminance region can be suppressed.

In contrast, when the photometric value is very high, it is estimated that the image has been captured in fine weather or with rear light. In this situation, since the difference between sunlight and shadow is large, with the hard gradation conversion characteristic shown in FIG. 21, white and block gradations are highly likely to be lost. Thus, when the photometric value is very high, as shown in FIG. 19, the gradation conversion control part 24B designates a hard gradation limit of the gradation conversion characteristic so as to prevent white gradation and black gradation from being lost.

As the reliability of the photometric value, the frequency of the photometric value on the screen, the fluctuation of the photometric value on the screen, the chronological fluctuation on the screen, or the like can be used. It is preferred to adjust the level range of the gradation conversion characteristic using such reliability.

(7) Adjustment of Gradation Conversion Characteristic According To Color Temperature

The gradation conversion control part 24B obtains a color temperature (estimated value) of the light source as a judgment material for an adjustment of the white balance from the color distribution evaluating part 17a. The color temperature may be estimated with a white color designated in a pre-set white balance by the user besides the image signal as the judgment material. Alternatively, the color temperature may be estimated with a manual setting value of the white balance.

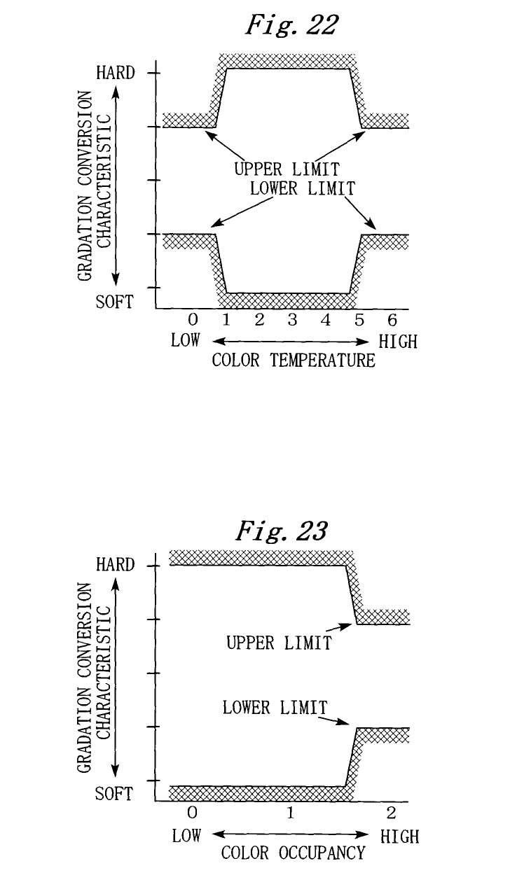

FIG. 22 is a schematic diagram showing a way of an adjustment of the gradation conversion characteristic according to the color temperature.

When a color temperature at capture of an image signal deviates from the standard range of the color temperature that the color filter array of the image sensor 13 expects, the differences among levels of color components (RGB) that are output from the image sensor 13 becomes large. In this state, since histogram statistics of these color components largely deviate, an inaccurate standard characteristic tends to be selected. Thus, as shown in FIG. 22, when the color temperature is an extreme value, the gradation conversion control part 24B designates a hard gradation limit and a soft gradation limit of the gradation conversion characteristic so that an extreme gradation conversion characteristic is not selected.

The “deviation of the color temperature from the standard range” corresponds to the reliability of the color temperature. As the reliability of the color temperature, the fluctuation (namely, the occupation rate) of the color temperatures of the entire image or the influence of the color temperature to the entire screen may be used. It is preferred to adjust the level range of the gradation conversion characteristic using such reliability.

(8) Adjustment of Gradation Conversion Characteristic According To Color occupancy

The gradation conversion control part 24B obtains color distribution information on an image signal from the color distribution evaluating part 17a. According to the color distribution information, the gradation conversion control part 24B analyzes the color occupancy of the image signal.

In this case, the “color occupancy” represents the screen occupancy of a color of the image signal.

For example, as an easy method for analyzing the color occupancy, it is preferred to perform a statistic processing for a hue component of the image signal and take histogram statistics of the hue. In this case, it is able to obtain hue with high occurrence frequency and the occurrence frequency of every hue (equivalent to color occupancy) together.

FIG. 23 is a schematic diagram showing a way of an adjustment of the gradation conversion characteristic according to the color occupancy.

When the color occupancy is very high, since the image signal is biased to a particular color, the difference between levels of color components (RGB) that are output from the image sensor 13 tends to become large. In this state, since the histogram statistics of individual color components largely differ, an inaccurate standard characteristic is often selected. Thus, as shown in FIG. 23, at a very high color occupancy, the gradation conversion control part 24B designates a hard gradation limit and a soft gradation limit of the gradation conversion characteristic so that an extreme gradation conversion characteristic is not selected.

(9) Adjustment of Gradation Conversion Characteristic According to Image Sensitivity

The gradation conversion control part 24B obtains the setting of image sensitivity of the image sensor 13 (for example, the setting of the gain of the amplifier 14) from the imaging control part 31.

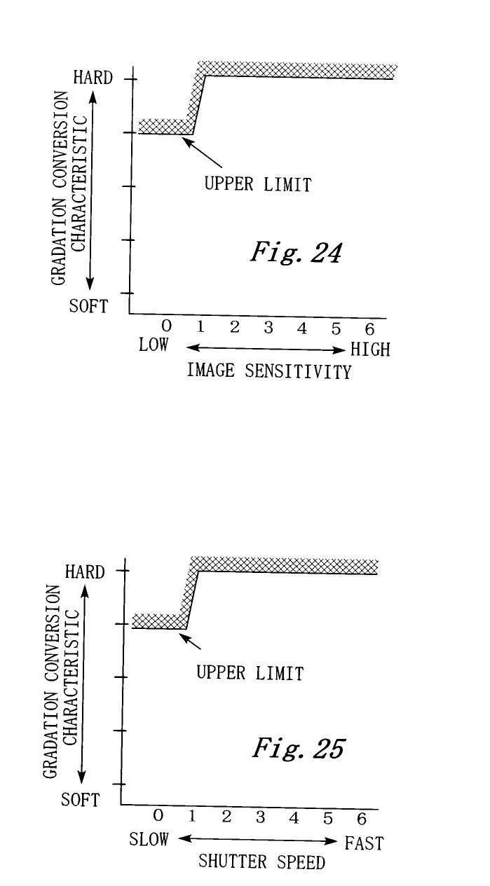

FIG. 24 is a schematic diagram showing a way of an adjustment of the gradation conversion characteristic according to the image sensitivity.

As the image sensitivity increases, the S/N ratio of the image signal deteriorates. In this case, when the gradation contrast is excessively emphasized, noise in the medium luminance region becomes obstructive.

Thus, as shown in FIG. 24, when the image sensitivity is higher than the standard range, the gradation conversion control part 24B designates a hard gradation limit of the gradation conversion characteristic.

With such a limit, the obstruction of noise in the image signal can be suppressed.

(10) Adjustment of Gradation Conversion Characteristic According to Shutter Speed

The gradation conversion control part 24B obtains an exposure condition from the imaging control part 31. According to the exposure condition, the gradation conversion control part 24B obtains the shutter speed.

FIG. 25 is a schematic diagram showing a way of an adjustment of the gradation conversion characteristic according to the shutter speed.

When the shutter speed is slow to some extent for example upon night photography, noise due to long time exposure tends to occur. In this case, when the gradation contrast is excessively emphasized, noise becomes obstructive.

Thus, as shown in FIG. 25, when the shutter speed is slower than the standard range, the gradation conversion control part 24B designates a hard gradation limit of the gradation conversion characteristic.

With the limit, the obstruction of noise in the image signal can be suppressed.

(11) Adjustment of Gradation Conversion Characteristic According to Illumination Information

The gradation conversion control part 24B obtains illumination information from the MPU 30a of the flash device 30.

The illumination information is preferably the presence/absence of flash light, flash GN (flash light amount), or the like.

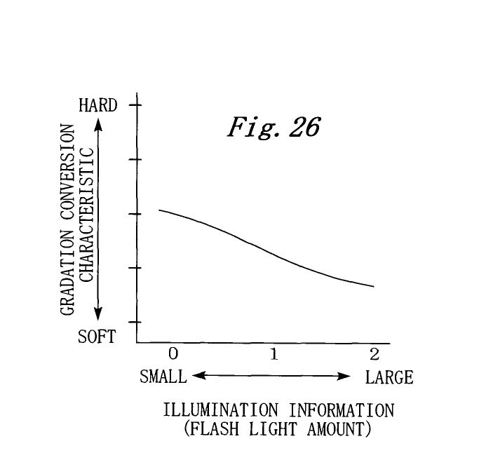

FIG. 26 is a schematic diagram showing a way of an adjustment of the gradation conversion characteristic according to the illumination information (in this example, the flash light amount).

With a large flash light amount, the difference between a lighted portion and a shadow portion is large. In such a situation, when the gradation contrast is excessively emphasized, white gradation and black gradation of the image signal are likely to be lost.

Thus, as shown in FIG. 26, as the flash light amount increases, the gradation conversion control part 24B shifts the gradation conversion characteristic to the softer gradation side than the standard characteristic.

By adjusting the gradation conversion characteristic according to the illumination information, the gradation can be prevented from being lost. As a result, an image signal of natural and subtle gradation can be obtained.

The distance to the object is preferably included in items for evaluation of the reliability of the illumination information. As the distance to the object increases, the degree at which the illumination affects the entire screen (namely, the degree of the reflectance) decreases so that the reliability of the illumination information also decreases. It is preferred to adjust the level range of the gradation converting characteristic using such reliability.

[Description of Operation of Noise Suppression Control Part 24C]

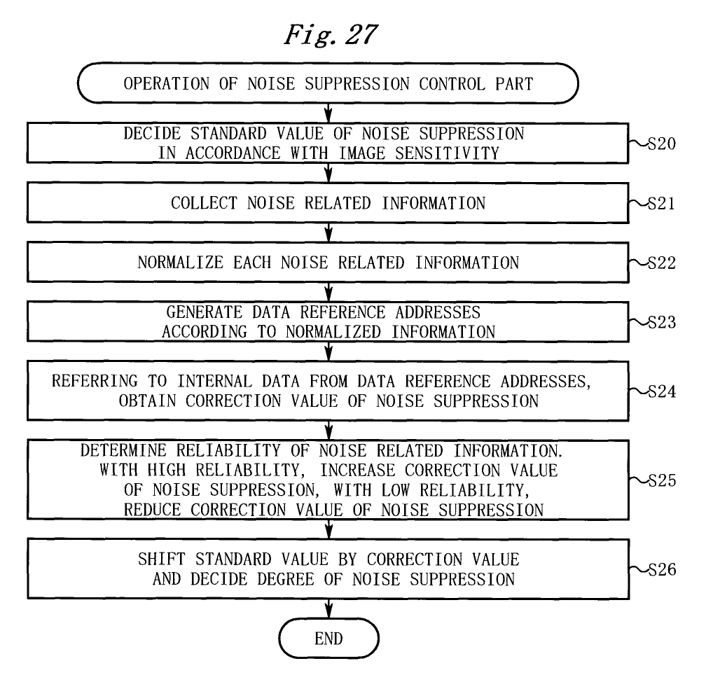

FIG. 27 is a flow chart for describing the operation of the noise suppression control part 24C. Next, in the order of step numbers shown in FIG. 27, the operation of the noise suppression control part 24C will be described.

Step 20: The noise suppression control part 24C obtains image sensitivity from the imaging control part 31.

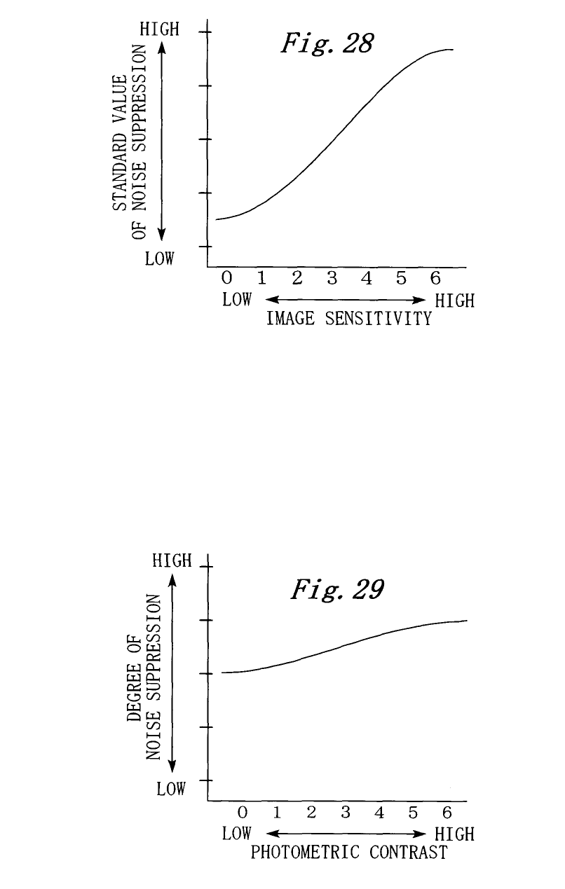

FIG. 28 is a schematic diagram showing the relation between the “image sensitivity” and the “standard value of noise suppression”.

Normally, the lower the image sensitivity becomes, the lower the S/N ratio of the image signal. Thus, as shown in FIG. 28, as the image sensitivity becomes higher, the noise suppression control part 24C sets the noise suppression to a larger value than the standard value.

Step S21: The noise suppression control part 24C obtains noise related information that influences noise representation of the image signal.

The “noise representation” represents the representation of noise in an image signal that is displayed or printed. For example, the “noise representation” is the size and frequency of a piece of noise, the amplitude of noise, noise condition of each color component, spatial frequency distribution of noise, representation of noise in a flat portion, representation of noise in edges, representation of noise in details, representation of noise in a dark portion, representation of noise in a medium luminance region, representation of noise in a highlight portion, and so forth.

The noise suppression control part 24C obtains for example the following noise related information besides the image sensitivity obtained at step S20.

(A) a photometric value (divided photometric values) of the divided photometry sensor 29,

(B) illumination information transferred from the MPU 30a of the flash device,

(C) an exposure condition transferred from the imaging control part 31,

(D) lens information transferred from the in-lens MPU 12a,

(E) image sensitivity transferred from the imaging control part 31,

(F) color information (for example, a color temperature of a light source, a hue angle, and chromaticness, and so forth), and

(G) a color occupancy (a value that represents a screen occupancy of a color) transferred from the color distribution evaluating part 17a.

Step S22: The noise suppression control part 24C normalizes (groups) noise related information according to the normalization table shown in FIG. 3.

Proper normalizing steps largely vary according to the characteristic of the image sensor 13 for use. Thus, it is preferred to perform a photographing experiment of the electronic camera 11, obtain the influence of the noise related information against the noise representation, and normalize pieces of the noise related information that more influence the noise representation at smaller steps.

Step S23: The noise suppression control part 24C combines normalized values of individual pieces of the noise related information so as to generate unique reference addresses. The data reference addresses correspond to addresses of the internal data area of the noise suppression control part 24C. In the internal data area, correction values of the noise suppression according to a way of an adjustment that will be described later combinations are correlated with combinations of the normalized values.

Step S24: The noise suppression control part 24C references the internal data area according to the data reference addresses and obtains correction values of the noise suppression.

Step S25: The noise suppression control part 24C determines the reliability of the noise related information. In this case, the reliability represents the degree of how much the result of the image processing can be estimated with the noise related information. For example, it is preferred to determine the reliability with the occurrence frequency or fluctuation of the noise related information. Alternatively, it is preferred to determine the reliability in accordance with how much the noise related information influences the entire image signal.

The noise suppression control part 24C adjusts the correction value according to the reliability. For example, as the reliability is high, the noise suppression control part 24C causes the correction value to be apart from the standard value. In contrast, as the reliability lowers, the noise suppression control part 24C causes the correction value to be closer to the standard value.

Step S26: The noise suppression control part 24C shifts the standard value of the noise suppression by the correction value and finally decides the degree of the noise suppression. The noise suppression control part 24C transfers the degree of the noise suppression to the noise suppressing part 19. The noise suppressing part 19 executes the noise suppression for the image signal according to the degree of the noise suppression.

[Adjustment of Degree of Noise Suppression]

An optimum value of the degree of the noise suppression largely fluctuates depending on the dynamic range and noise characteristic of the image sensor 13 of the electronic camera for use. Thus, instead of providing real optimum values of individual electronic cameras, the Specification describes an essential way of an adjustment of noise suppression in detail.

First of all, those in the art sets forth the degree of the noise suppression (hereinafter referred to as “standard value”) with the image sensitivity. Next, they vary the standard characteristic according to a way of an adjustment that will be described in the following . In these procedures, the embodiment can be in reality implemented.

(1) Adjustment of Noise Suppression According To Photometric Contrast

The noise suppression control part 24C obtains divided photometric values from the divided photometry sensor 29. The divided photometric values are values of which the field is dividedly measured. The noise suppression control part 24C obtains the difference between bright and dark levels (or the ratio thereof) of the divided photometric values. As a result, the noise suppression control part 24C obtains the photometric contrast of the field.

FIG. 29 is a schematic diagram showing a way of an adjustment of the noise suppression according to the photometric contrast.

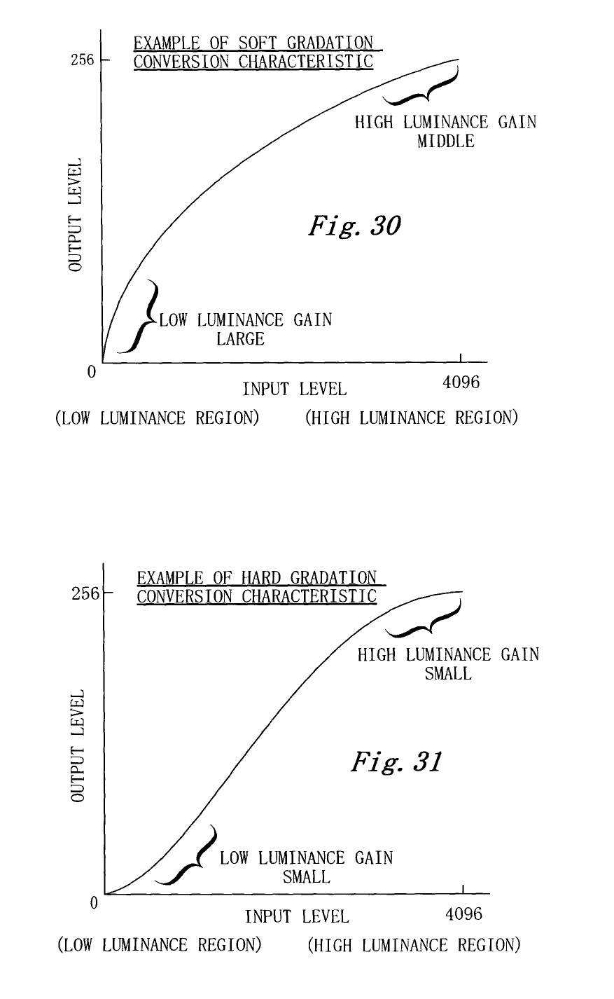

Normally, as the photometric contrast goes high, white gradation and black gradation are likely to be lost. In this state, a not-shown gradation conversion control part is likely to set the gradation conversion characteristic to a value of a soft gradation. For a soft gradation conversion characteristic, as shown in FIG. 30, the amplitude gain in the low luminance region (hereinafter referred to as “low luminance gain”) is set to a high value so as to prevent black gradation from being lost. Thus, the noise amplitude in the low luminance region gets wide and obstructive. Thus, as shown in FIG. 29, as the photometric contrast rises, the noise suppressing part 19 shifts the degree of the noise suppression to a larger value than the standard value. As a result, the obstruction of noise in the low luminance region can be suppressed.

In contrast, at a low photometric contrast, to clarify the gradation contrast, the gradation conversion characteristic is likely to be set to a value on the hard gradation side. In the gradation conversion characteristic on the hard gradation side, as shown in FIG. 31, to increase the contrast in the medium luminance region, a low luminance gain is set to a small value. In this case, the noise amplitude in the low luminance region is decreased. As a result, noise relatively becomes non-obstructive. Thus, as shown in FIG. 29, as the photometric contrast increases, the noise suppressing part 19 shifts the degree of the noise suppression to the low side of the standard value. As a result, the reproduction of the details of the image signal can be improved.

When noise in the medium luminance region is obstructive in the image sensor 13, as the photometric contrast decreases, it is preferred to shift the degree of the noise suppression to be higher than the standard value.

It is preferred to determine the reliability of the photometric contrast from the fluctuation of the photometric contrast on the screen. It is preferred to adjust the level range of the nose suppression using such reliability.

(2) Adjustment of Noise Suppression According to Color Temperature

The noise suppression control part 24C obtains a color temperature (estimated value) of the light source as a judgment material for an adjustment of the white balance from the color distribution evaluating part 17a. The color temperature may be estimated with a white color designated in a pre-set white balance by the user besides the image signal as the judgment material. Alternatively, the color temperature may be estimated with a manual setting value of the white balance.

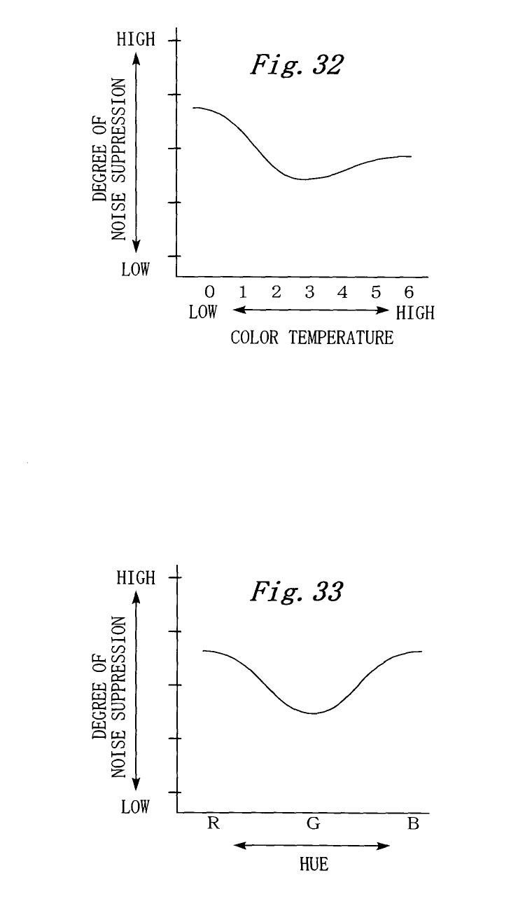

FIG. 32 is a schematic diagram showing a way of an adjustment of the noise suppression according to the color temperature.

When a color temperature at capturing an image is outside an expected standard range of the color temperature in the color filter array of the image sensor 13, the differences among levels of color components (RGB) that are output from the image sensor 13 are large. In this state, the exposure is likely to be set in accordance with a color component of the highest level. Accordingly, the S/N ratio of a signal component of the lowest level tends to deteriorate. Thus, as shown in FIG. 32, when the color temperature is extremely high or low, the noise suppression control part 24C shifts the degree of the noise suppression to be higher than the standard value.

At a low color temperature, it is likely that an object is captured in a room with low luminance (like with candles). Thus, as the color temperature is low, the noise suppression control part 24C largely shifts the degree of the noise suppression to be much higher than the standard value. However, the shifting of the noise suppression is more accurately done when using the photometric value than the color temperature; therefore, it is preferred to control the noise suppression depending on the photometric value if the photometric value is used as the noise related information.

The “deviation of the color temperature from the standard range” corresponds to the reliability of the color temperature. In other words, when the deviation is large, it is likely that the color temperature is inaccurately measured. As the reliability of the color temperature, the fluctuation (namely, the occupation rate or the degree of influence) in the color temperatures of the entire image may be used. It is preferred to adjust the level range of the noise suppression using such reliability.

(3) Adjustment of Noise Suppression According to Hue

The noise suppression control part 24C obtains color distribution information on an image signal from the color distribution evaluating part 17a. According to the color distribution information, the noise suppression control part 24C analyzes hue of the image signal.

In this case, the “hue” is preferably hue of the main range (the center portion of the screen, the AF selection region, or the like) of the image, hue whose occurrence frequency is high, hue of a large area of the image, an average value of hue of the entire image, or the like.

For example, as the hue analyzing method, it is preferred to perform a statistic processing for a hue component of the image signal and takes histogram statistics of the hue.

FIG. 33 is a schematic diagram showing a way of an adjustment of the noise suppression according to the hue.

Normally, human eyes have a high sensitivity for hue of green. Thus, the hue of green tends to influence the brightness of the image signal. In addition, since the green image region contains many detail components such as tree leaves or glass lands, noise is therein relatively non-obstructive. In contrast, red and blue image regions are mainly contained in a plane portion such as human skins and blue sky both having a relatively moderate color variation.

Thus, upon determining that the image signal has greenish hue, as shown in FIG. 33, the noise suppression control part 24C shifts the degree of the noise suppression to be lower than the standard value. In such an operation, it is able to obtain an image signal having good subtle expression, sharpness, and solidity as well as a properly kept detail green component. When the noise suppression in green is set on the low side, it is preferred to adjust the degree of the noise suppression within the range that dirk spots on a face or the like, which often contains a lot of green components, can be removed.

In contrast, upon determining that the image signal has reddish or greenish hue, as shown in FIG. 33, the noise suppression control part 24C shifts the degree of the noise suppression to be higher than the standard value. In such an operation, images mainly containing a portrait or a blue sky can be represented with smoothness and less roughness.

At determining the hue, the color occupancy is preferably also determined. This enables comparative determination of how much specific hue occupies the screen, realizing more accurate hue determination.

For evaluating the reliability of the hue, the color occupancy, the occurrence frequency of hue, the fluctuation of hue, or the like can be used. It is preferred to adjust the level range of the noise suppression using such data.

(4) Adjustment of Noise Suppression According to Chromaticness

The noise suppression control part 24C obtains color distribution information on an image signal from the color distribution evaluating part 17a. According to the color distribution information, the noise suppression control part 24C analyzes chromaticness of the image signal.

In this case, the “chromaticness” is preferably chromaticness of the main range (the center portion of the screen, the AF selection region, or the like) of the image, chromaticness that frequently occurs on the screen, chromaticness of a large area portion of the image, an average value of chromaticness of the entire image, or the like. As an easy method for analyzing chromaticness, it is preferred to take histogram statistics of the chromaticness of the image signal.

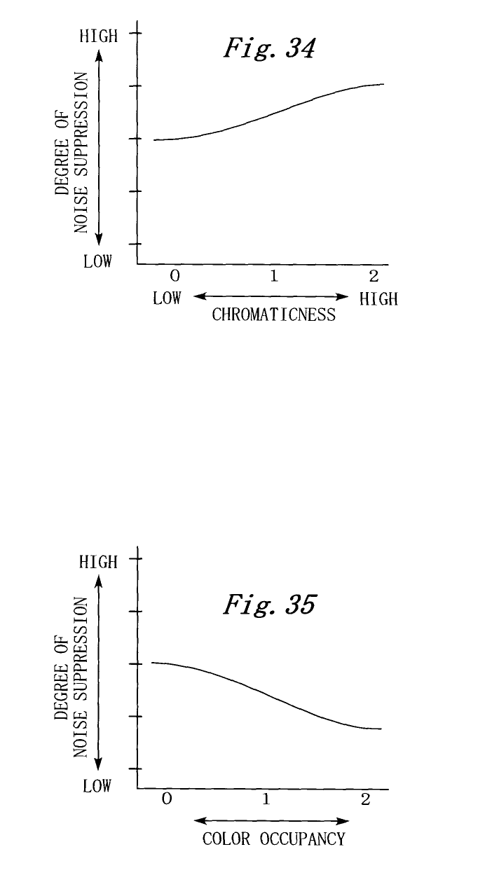

FIG. 34 is a schematic diagram showing a way of an adjustment of the noise suppression according to the chromaticness.

It is needless to say that an image signal of a bright object has high chromaticness. Emphasizing the contour of the image signal with high chromaticness causes obstructive color moirés.

Thus, as shown in FIG. 34, when the chromaticness of the image signal is higher than the standard range, the noise suppression control part 24C shifts the degree of the noise suppression to be higher than the standard value. With such a setting, an image signal with small color moirés can be obtained.

In this case, in addition to the effect of the suppression of color moires by the color noise suppressing part 23, it is preferred to control the degree of the noise suppression.

As the reliability of the chromaticness, the occurrence frequency of chromaticness on the screen, the fluctuation of chromaticness, or the like can be used. It is preferred to adjust the level range of the noise suppression using such reliability.

(5) Adjustment of Noise Suppression According to Color Occupancy

The noise suppression control part 24C obtains color distribution information on an image signal from the color distribution evaluating part 17a. According to the color distribution information, the noise suppression control part 24C analyzes a color occupancy of the image signal.

In this case, the “color occupancy” represents a screen occupancy of a color of the image signal.

As an easy method for analyzing the color occupancy, it is preferred to perform a statistic processing for a hue component of the image signal and take histogram statistics thereof. In this case, hue whose occurrence frequency is high and an occurrence frequency of hue (equivalent to the color occupancy) can be obtained together.

FIG. 35 is a schematic diagram showing a way of an adjustment of the noise suppression according to the color occupancy.

When the color occupancy is excessively high, since the image signal is biased to a particular color, an inaccurate degree of the noise suppression is likely to be selected. Thus, as shown in FIG. 35, as the color occupancy increases, the noise suppression control part 24C shifts the degree of the noise suppression to be lower than the standard value (in this case, the noise suppression control part 24C allows the user to perform an image processing later).

(6) Adjustment of Noise Suppression According to Photometric Value

The noise suppression control part 24C obtains divided photometric values from the divided photometry sensor 29. According to the divided photometric values, the noise suppression control part 24C obtains a photometric value.

in this case, the “photometric value” is preferably a photometric value of the main range (the center portion of the screen, the AF selection area, or the like) of the image, the minimum, maximum, or medium value of the divided photometric values, a photometric value of a large area portion of the image, an average value of the divided photometric values of the entire image, or the like.

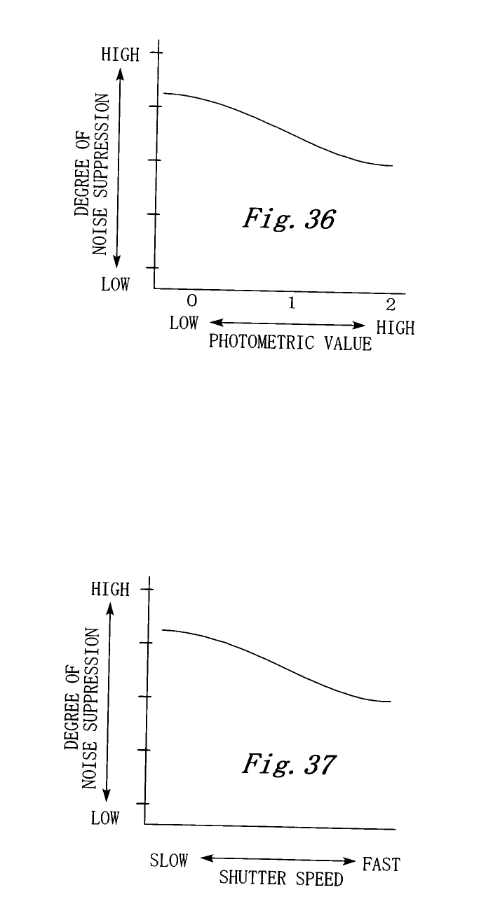

FIG. 36 is a schematic diagram showing a way of an adjustment of the noise suppression according to the photometric value.

When the photometric value is excessively low, the S/N ratio of the image signal deteriorates. Thus, as shown in FIG. 36, as the photometric value decreases, the noise suppression control part 24C shifts the degree of the noise suppression to be higher than the standard value. As a result, an image signal without suppression of rough impression can be obtained.

As the reliability of the photometric value, the frequency of the photometric value on the screen, the fluctuation of the photometric value on the screen, the chronological fluctuation, or the like can be used. It is preferred to adjust the level range of the noise suppression using such reliability.

(7) Adjustment of Noise Suppression According to Shutter Speed

The noise suppression control part 24C obtains an exposure condition from the imaging control part 31. According to the exposure condition, the noise suppression control part 24C obtains a shutter speed.

FIG. 37 is a schematic diagram showing a way of an adjustment of the noise suppression according to the shutter speed.

When the shutter speed is slow to some extent for example upon night photographing, noise due to long time exposure tends to occur. In this case, excessive emphasis on the gradation contrast causes obstructive noise.

Thus, as shown in FIG. 37, when the shutter speed decreases to a value smaller than the standard range, the noise suppression control part 24C shifts the degree of the noise suppression to be higher than the standard value.

When the shutter speed is at a value smaller than the standard range, for suppression of noise in impulses due to a long time exposure, a noise suppressing processing with a median filter is preferably performed.

(8) Adjustment of Noise Suppression According to Illumination Information

The noise suppression control part 24C obtains illumination information from the MPU 30a of the flash device 30.

The illumination information is preferably the presence/absence of flash light, flash GN (flash light amount), or the like.

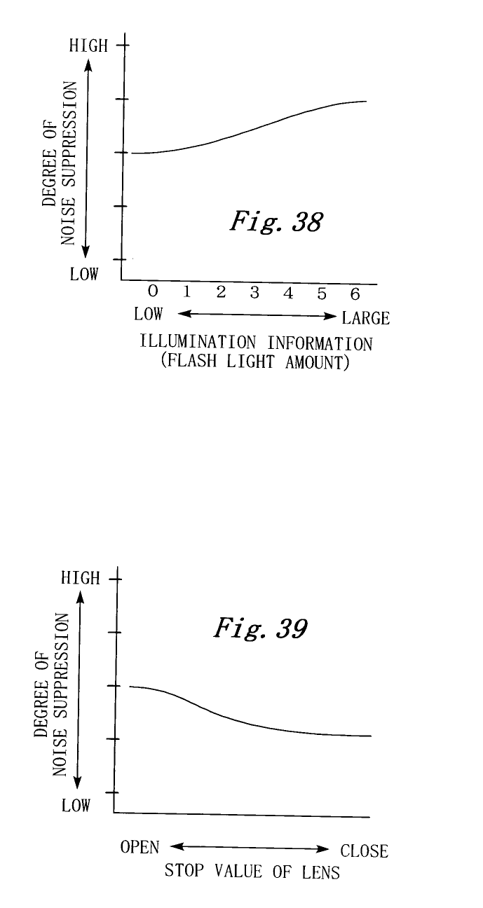

FIG. 38 is a schematic diagram showing a way of an adjustment of the noise suppression according to the illumination information (in this example, the flash light amount).

With a large flash light amount, the difference between a lighted portion and a shadow portion is large. In such a situation, the gradation characteristic is likely to be set on the soft gradation side. In the soft gradation conversion characteristic, as shown in FIG. 30, to prevent the black gradation from being lost, an amplitude gain of the low luminance region (hereinafter referred to as “low luminance gain”) is set to a high value. As a result, the noise amplitude in the low luminance region is increased and becomes obstructive. Thus, as shown in FIG. 38, as the flushing light amount increases, the noise suppressing part 19 shifts the degree of the noise suppression to be higher than the standard value.

When information on the exposure condition and light adjustment are considered in addition to the illumination information, a daylight synchronized flash, a slow synchronized flash, a variable stop synchronized flash, an increased illumination, or a bounce illumination can be detected. In this case, according to the illumination state, the degree of the nose characteristic can be controlled. For example, in such an illumination state, since the user intentionally uses a photographing technique, it is preferred to shift the degree of the noise suppression to be lower than the standard value (in this case, the noise suppression control part 24C allows the user to perform an image processing later).

As the reliability of the illumination information, the distance to the object is preferable. As the distance to the object increases, the degree at which the illumination affects the entire screen (namely, the degree of the reflectance) decreases. Thus, the reliability of the illumination information also decreases. It is preferred to adjust the level range of the noise suppression using such reliability.

(9) Adjustment of Noise Suppression According to Lens Stop Value

The noise suppression control part 24C obtains a lens stop value at capture of an image signal as one piece of lens information from the in-lens MPU 12a.

FIG. 39 is a schematic diagram showing a way of an adjustment of the noise suppression according to the lens stop value.

When the stop value of the lens is set on the opener side than the standard range, large unsharp portions tend to occur before and after the in-focus position. In this state, when the contrast at the in-focus position is low, the image signal generally has soft gradation. Thus, in such a situation, a hard gradation conversion is likely to be selected.

The hard gradation conversion may cause obstructive rough impression in the medium luminance region (for example a wide unsharp portion). In this case, as the stop of the lens is set on the open side, it is preferred that the noise suppression control part 24C should shift the degree of the noise suppression to be higher than the standard value (for example, refer to FIG. 39).

Selection of a hard gradation conversion may sometimes cause improvement in the rough impression in the low luminance region. As a result, noise in the entire image may become non-obstructive. In such an electronic camera, as the stop of the lens is set on the open side, it is preferred that the noise suppression control part 24C should shift the degree of the noise suppression to be lower than the standard value.

(10) Adjustment of Noise Suppression According to MTF Characteristic of Lens

The noise suppression control part 24C obtains an MTF (Modulation Transfer Function) characteristic at capture of an image signal as one piece of lens information from the in-lens MPU 12a.

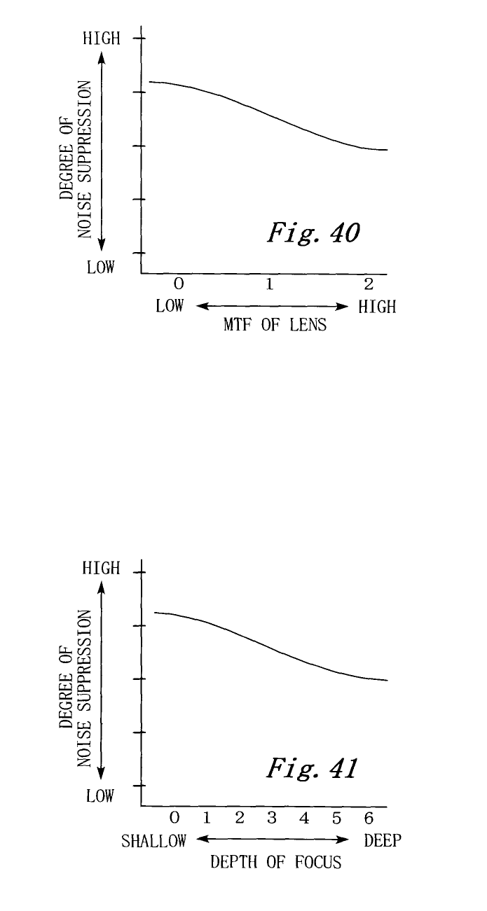

FIG. 40 is a schematic diagram showing a way of an adjustment of the noise suppression according to the MTF characteristic.

When the MTF characteristic is lower than the standard, it is likely that variances in the edges of the image signal are gradual, therefore, in such a situation, a harder gradation conversion is likely to be selected.

The selection of the hard gradation conversion may cause obstructive rough impression in the medium luminance region (for example, a large flat portion). In this case, as the MTF characteristic decreases, it is preferred that the noise suppression control part 24C should shift the degree of the noise suppression to be higher than the standard value (for example, refer to FIG. 40).

On the other hand, selection of the hard gradation conversion may improve roughness in the low luminance region. As a result, noise in the entire image may become non-obstructive. In such an electronic camera, as the MTF characteristic decreases, it is preferred that the noise suppression control part 24C should shift the degree of the noise suppression to be lower than the standard value.

As items for evaluation of the reliability of the MTF characteristic, a stop value at capture of an image signal, a distance to an object at the capture of an image signal, or the like can be used. With such reliability, it is possible to infer a degree with which an MTF characteristic obtained from lens information coincides with an MTF characteristic at capture of an image signal. It is preferred to adjust the level range of the noise suppression using such reliability.

(11) Adjustment of Noise Suppression According to Depth of Focus Of Lens

The noise suppression control part 24C obtains a depth of focus at capture of an image signal as one piece of illumination information from the in-lens MPU 12a.

FIG. 41 is a schematic diagram showing a way of an adjustment of the noise suppression according to the depth of focus.

When the depth of focus is shallower than the standard, large unsharp portions occur before and after the in-focus position. At that point, when the contrast at the in-focus position is low, the image signal has soft gradation. Thus, in such a situation, a hard gradation conversion is likely to be selected.

The selection of a hard gradation conversion may cause obstructive rough impression in the medium luminance region (for example a wide flat portion). In this case, as the depth of focus is shallower, it is preferred that the noise suppression control part 24C should shift the degree of the noise suppression to be higher than the standard value (for example, refer to FIG. 41).

In contrast, the selection of a hard gradation conversion may sometimes improve rough impression in the low luminance region. As a result, noise in the entire screen may become non-obstructive. In such an electronic camera, as the depth of focus is shallower, it is preferred that the noise suppression control part 24C should shift the degree of the noise suppression to be lower than the standard value.

[Description of Operation of Chromaticness Modulation Control Part 24D]

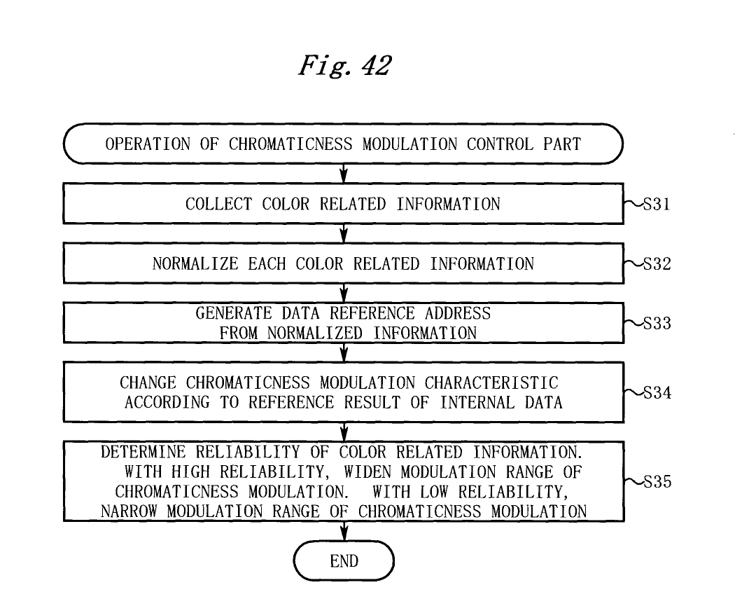

FIG. 42 is a flow chart for describing the operation of the chromaticness modulation control part 24D. Next, in the order of step numbers shown in FIG. 42, the operation of the chromaticness modulation control part 24D will be described.

Step S31: The chromaticness modulation control part 24D obtains color related information that influences color representation of an image signal to be processed.

The “color representation” means representation of a color of an image signal that is displayed or printed. The “color representation” is for example brightness or clarity of a color, dullness of a color, eccentricity of hue, tone of a color (high key, low key, warm tone, cool tone, and so forth), representation of the differences among subtle colors, representation of a color of a plane portion, representation of a color of edges, representation of a color of details, representation of a color in a low luminance region, representation of a color of a highlighted portion, a color deviation, an unnatural color, color noise, and so forth.

The chromaticness modulation control part 24D collects for example the following color related information.

(A) an adjustment value of color reproduction transferred from the matrix converting part 21,

(B) information on image sensitivity transferred from the gamma converting part 20,

(C) information on a gradation conversion characteristic transferred from the gamma converting part 20,

(D) a photometric value (divided photometric values) of the divided photometry sensor 29,

(E) illumination information transferred from the MPU 30a of the flash device,

(F) an exposure condition transferred from the MPU 30a of the flash device,

(G) lens information transferred from the in-lens MPU 12a,

(H) color information (for example, a color temperature of a light source, a hue angle, and hue), and

(I) a color occupancy (value that represents a screen occupancy of a color) transferred from the color distribution evaluating part 17a.

Step S32: The chromaticness modulation control part 24D normalizes each piece of color related information. Proper normalizing steps largely vary according to the characteristic of the image sensor 13 for use. Thus, it is preferred to perform a photographing experiment of the electronic camera 11, obtain the influence of color related information against the color representation, and normalize pieces of the color related information that more influence the color representation at smaller steps.

Step S33: The chromaticness modulation control part 24D combines normalized values of individual pieces of the color related information so as to generate unique data reference addresses. The data reference addresses correspond to addresses of the internal data area of the chromaticness modulation control part 24D. In the internal data area, guide numbers of the chromaticness modulation characteristic according to real image evaluation and a predetermined rule that will be described later are correlated with combinations of the normalized values.

Step S34: The chromaticness modulation control part 24D references internal data according to the data reference address and obtains a guide number of the chromaticness modulation characteristic.

Step S35: The chromaticness modulation control part 24D determines the reliability of the color related information. In this case, the reliability represents the degree of how much the result of the image processing can be estimated with the color related information. For example, it is preferred to determine the reliability with the occurrence frequency or fluctuation of the color related information. Alternatively, it is preferred to determine the reliability in accordance in accordance with at which the color related information influences the entire image signal.

When the reliability is high, the chromaticness modulation control part 24D causes the guide number to be apart from the standard value. In contrast, when the reliability is low, the chromaticness modulation control part 24D causes the guide number to be close to the standard number.

The chromaticness modulation control part 24D transfers the obtained guide number to the color noise suppressing part 23. The color noise suppressing part 23 selects a chromaticness modulation characteristic from the internal function table according to the guide number and executes a chromaticness modulation for the image signal.

[Adjustment of Chromaticness Modulation Characteristic]

An optimum chromaticness modulation characteristic largely fluctuates depending on the dynamic range, noise characteristic, and so forth of the image sensor 13 of the electronic camera for use. Thus, instead of providing real optimum values of individual electronic cameras, the Specification describes an intrinsic way of adjustment of chromaticness modulation characteristic in detail.

When varying a predetermined standard chromaticness modulation characteristic (hereinafter referred to as “standard characteristic”) according to a way of an adjustment that will be described later, those in the art can implement the embodiment.

(1) Chromaticness Modulation Characteristic According to Adjustment Value of Color Reproduction

FIG. 43 is a schematic diagram showing a way of an adjustment of the chromaticness modulation characteristic according to an adjustment value of the color reproduction. FIG. 43 shows a plurality of curves of the chromaticness modulation characteristic. Among these curves, with a combination of a curve in a low luminance region and a curve in a high luminance region, the chromaticness modulation characteristic can be selected with a high degree of freedom.

As the adjustment value of the color reproduction increases, the signal level of the color signal also increases. In this case, color noise in the low luminance region and an unnecessary color becomes obstructive. As shown in FIG. 43, as the adjustment value of the color reproduction increases, the chromaticness modulation control part 24D controls the chromaticness gains in the low luminance region and high luminance region so that they become lower than the standard characteristic. As a result, even if the color reproduction is set to a higher value than normal, the chromaticness levels in the low luminance region and the high luminance region are properly suppressed. This consequently prevents too obvious color noise and unnatural color.

The reliability of the adjustment value of the color reproduction can be determined from the reliability of the influential factor that is associated with the determining of the adjustment value. It is preferred to adjust the level range of the chromaticness modulation characteristic using such reliability.

(2) Chromaticness Modulation Characteristic According to Adjustment Value of Image Sensitivity

FIG. 44 is a schematic diagram showing a way of an adjustment of the chromaticness modulation characteristic according to a setting value of image sensitivity. Normally, when the setting value of the image sensitivity is high, the S/N ratio of the color signal deteriorates. In this case, color noise in the low luminance region and an unnatural color in the high luminance region deteriorate and become obstructive. Thus, as the setting value of the image sensitivity increases, as shown in FIG. 44, the chromaticness modulation control part 24D controls the chromaticness gains in the low luminance region and the high luminance region so that they become lower. As a result, when the image sensitivity is set to a high value, the chromaticness levels in the low luminance region and high luminance region are suppressed. As a result, color noise and an unnecessary color are not so emphasized.

(3) Chromaticness Modulation Characteristic According to Adjustment Value of Gradation Conversion Characteristic

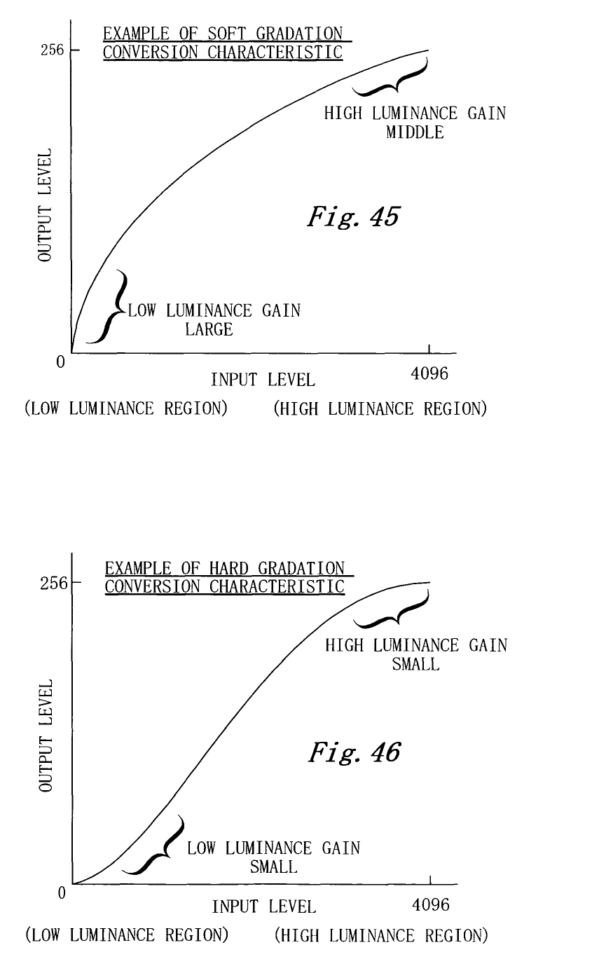

FIG. 45 is a schematic diagram showing an example of a soft gradation conversion characteristic. The soft gradation conversion characteristic is a gamma curved characteristic with a large low luminance gain (the slope of the gradation conversion in the low luminance region) and a medium high luminance gain (the slope of the gradation conversion in the high luminance region) .

FIG. 46 is a schematic diagram showing an example of a hard gradation conversion characteristic. The hard gradation conversion characteristic is an S letter shaped characteristic that increases the contrast of the medium luminance region with a low luminance gain and a high luminance gain set to low values.

The chromaticness modulation control part 24D controls the chromaticness modulation characteristic according to a low luminance gain and a high luminance gain of the gradation conversion characteristic.

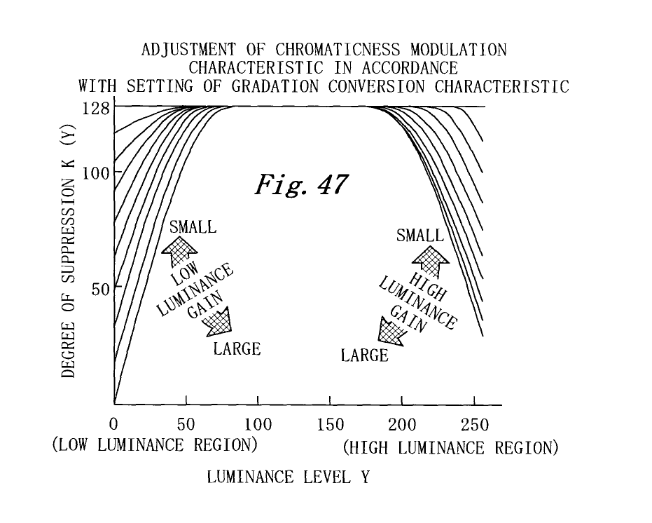

FIG. 47 is a schematic diagram showing a way of an adjustment of the chromaticness modulation characteristic according to a setting of the gradation conversion characteristic.

When the low luminance gain is large depending on a setting of the gradation conversion characteristic, the amplitude level of the color signal in the low luminance region increases. As a result, color noise deteriorates. Thus, as shown in FIG. 47, as the low luminance gain increases, the chromaticness modulation control part 24D adjusts the chromaticness gain to lower it. As a result, even if the low luminance gain set to a large value in the gradation conversion characteristic, the chromaticness level in the low luminance region is properly suppressed. As a result, the color noise is not so emphasized.

In contrast, when the high luminance gain is large due to a setting of the gradation conversion characteristic, the amplitude level of the color signal in the high luminance region increases. As a result, an unnatural color becomes obstructive. Thus, as shown in FIG. 47, as the high luminance gain increases, the chromaticness modulation control part 24D controls the chromaticness gain in the high luminance region so that it is lowered. As a result, even if the high luminance gain is set to a large value in the gradation conversion characteristic, the chromaticness level in the high luminance region is properly suppressed. As a result, an unnecessary color is not so emphasized.

The reliability of the gradation conversion characteristic can be determined with the reliability of the influential factor that is associated with the determining of the gradation conversion characteristic. It is preferred to adjust the level range of the chromaticness modulation characteristic using such reliability.

[Additional Description of Embodiment]

In the forgoing embodiment, the level of the image processing is controlled depending on a plurality of influential factors. Thus, even if the image processing of high level is set due to a part of the influential factors, the image processing is flexibly controlled with the rest of the influential factors taken into account. Judging all of the plurality of influential factors together as described above realizes accurate and detailed estimation of a present status of the image signal, and proper level control of the image processing.

However, the present invention is not limited to such an embodiment having a plurality of influential factors used. Instead, the present invention can be applied to the case where the level of the image processing is controlled according to one influential factor.

In addition, for such flexible image processing control, it is simple and preferable that the standard value should be updated in sequence for every influential factor and that the final update value should be selected as the level of the image processing. Moreover, it is preferred that the order of the update should be made such that the update for an influential factor that largely affects the image processing (as information that suppresses the image processing) is made last because it is the secure and accurate way. It is also preferred to compare reliabilities of the influential factors to dynamically vary the update order. With a fixed update order as described in the embodiment, the invention can be easily and quickly implemented referring to a table.

The image processing of the present invention is not limited to particular color systems (YCbCr, etc.). Generally, the image processing of the present invention is applicable to any color system (for example, primary color system, complementary color system, luminance color difference system, Lab color system, or HSB color system).

In the forgoing embodiment, the electronic camera 11 was exemplified. However, the present invention is not limited to such an example. For example, the present invention can be implemented as a single image processing apparatus separate from an imaging device (an electronic camera, a video camera, etc.).

In addition, the processing operation of the present invention may be coded as an image processing program that runs on a computer. The computer can function as an image processing apparatus by executing the image processing program. The forgoing image processing method may also be provided as a service through a communication line such as the Internet.

The invention is not limited to the above embodiments and various modifications may be made without departing from the spirit and scope of the invention. Any improvement may be made in part or all of the components.

What is claimed is:

1. An image processing apparatus, comprising:
an image processing part for performing an image processing on an image signal;
a control part for obtaining an influential factor of the image signal, to control a level of the image processing in accordance with the obtained influential factor, the influential factor being a factor that affects a result of the image processing.

2. The image processing apparatus as set forth in claim 11, wherein
the control part evaluates reliability of the influential factor to adjust a level range of the image processing in accordance with the evaluated reliability.

3. The image processing apparatus as set forth in claim 2, wherein
the control part evaluates the reliability of the influential factor based on how much the influential factor occupies the image signal, to adjust the level range of the image processing in accordance with the evaluated reliability.

4. The image processing apparatus as set forth in claim 2, wherein
the control part evaluates the reliability of the influential factor based on how much the influential factor is reflected in the image signal, to adjust the level range of the image processing in accordance with the evaluated reliability.

5. The image processing apparatus as set forth in claim 11, wherein:
the image processing part comprises at least a color reproduction adjusting part for varying chromaticness of the image signal so as to adjust color reproduction for the image signal; and
the control part comprises at least a color reproduction control part for obtaining color related information to control a degree of adjustment of the color reproduction in accordance with the obtained color related information, the color related information being an influential factor affecting color representation of the image signal.

6. The image processing apparatus as set forth in claim 5, wherein:
at least one piece of the color related information is imaging condition(s) for the image signal; and
the color reproduction control part obtains the imaging condition for the image signal to control the degree of adjustment of the color reproduction in accordance with the obtained imaging condition.

7. The image processing apparatus as set forth in claim 5, wherein:
at least one piece of the color related information is analysis result(s) of the image signal; and
the color reproduction control part obtains the analysis result of the image signal to control the degree of adjustment of the color reproduction in accordance with the obtained analysis result.

8. The image processing apparatus as set forth in claim 6, wherein:
at least one of the imaging conditions is a photometric value of a field; and
the color reproduction control part obtains the photometric value at capture of the image signal to control the degree of adjustment of the color reproduction in accordance with the obtained photometric value.

9. The image processing apparatus as set forth in claim 6, wherein:
at least one of the imaging conditions is a divided photometric value of a field; and
the color reproduction control part obtains the divided photometric value at capture of the image signal to control the degree of adjustment of the color reproduction in accordance with a photometric contrast which is obtained from the divided photometric value.

10. The image processing apparatus as set forth in claim 6, wherein:
at least one of the imaging conditions is information on illumination to an object; and
the color reproduction control part obtains the information on illumination at capture of the image signal to control the degree of adjustment of the color reproduction in accordance with the obtained information on illumination.

11. The image processing apparatus as set forth in claim 6, wherein:
at least one of the imaging conditions is an exposure condition of the imaging part; and
the color reproduction control part obtains the exposure condition at capture of the image signal to control the degree of adjustment of the color reproduction in accordance with the obtained exposure condition.

12. The image processing apparatus as set forth in claim 6, wherein:
at least one of the imaging conditions is information on a lens of the imaging part; and
the color reproduction control part obtains the lens information at capture of the image signal to control the degree of adjustment of the color reproduction in accordance with the obtained lens information.

13. The image processing apparatus as set forth in claim 6, wherein:
at least one of the imaging conditions is image sensitivity of the imaging part; and
the color reproduction control part obtains the image sensitivity at capture of the image signal to control the degree of adjustment of the color reproduction in accordance with the obtained image sensitivity.

14. The image processing apparatus as set forth in claim 7, wherein:
at least one of the analysis results is color information on a color of the image signal; and
the color reproduction control part obtains the color information on the image signal to control the degree of adjustment of the color reproduction in accordance with the obtained color information.

15. The image processing apparatus as set forth in claim 7, wherein:
at least one of the analysis results is a color occupancy that represents how much a color of the image signal occupies a screen; and
the color reproduction control part obtains the color occupancy of the image signal to control the degree of adjustment of the color reproduction in accordance with the obtained color occupancy.

16. The image processing apparatus as set forth in claim 1, wherein:
the image processing part comprises at least a gradation converting part for converting gradation of the image signal; and
the control part comprises at least a gradation conversion control part for obtaining gradation related information to change a gradation conversion characteristic of the gradation converting part in accordance with the obtained gradation related information, the gradation related information being an influential factor that affecting gradation representation of the image signal.

17. The image processing apparatus as set forth in claim 16, wherein:
at least one piece of the gradation related information is imaging condition(s) for the image signal; and
the gradation conversion control part obtains the imaging condition for the image signal to change the gradation conversion characteristic in accordance with the obtained imaging condition.

18. The image processing apparatus as set forth in claim 16, wherein:
at least one piece of the gradation related information is analysis result(s) of the image signal; and
the gradation conversion control part obtains the analysis result of the image signal to change the gradation conversion characteristic in accordance with the obtained analysis result.

19. The image processing apparatus as set forth in claim 17, wherein:
at least one of the imaging conditions is a photometric value of a field; and
the gradation conversion control part obtains the photometric value at capture of the image signal to change the gradation conversion characteristic in accordance with the obtained photometric value.

20. The image processing apparatus as set forth in claim 17, wherein:
at least one of the imaging conditions is a divided photometric value of a field; and
the gradation conversion control part obtains the divided photometric value at capture of the image signal to change the gradation conversion characteristic in accordance with a photometric contrast which is obtained from the divided photometric value.

21. The image processing apparatus as set forth in claim 17, wherein:
at least one of the imaging conditions is information on illumination to an object; and
the gradation conversion control part obtains the information on illumination at capture of the image signal to change the gradation conversion characteristic in accordance with the obtained information on illumination.

22. The image processing apparatus as set forth in claim 17, wherein:
at least one of the imaging conditions is an exposure condition of the imaging part; and
the gradation conversion control part obtains the exposure condition at capture of the image signal to change the gradation conversion characteristic in accordance with the obtained exposure condition.

23. The image processing apparatus as set forth in claim 17, wherein:
at least one of the imaging conditions is information on a lens of the imaging part; and
the gradation conversion control part obtains the lens information at capture of the image signal to change the gradation conversion characteristic in accordance with the obtained lens information.

24. The image processing apparatus as set forth in claim 17, wherein:
at least one of the imaging conditions is image sensitivity of the imaging part; and
the gradation conversion control part obtains the image sensitivity at capture of the image signal to change the gradation conversion characteristic in accordance with the obtained image sensitivity.

25. The image processing apparatus as set forth in claim 18, wherein:
at least one of the analysis results is color information on a color of the image signal; and
the gradation conversion control part obtains the color information on the image signal to change the gradation conversion characteristic in accordance with the obtained color information.

26. The image processing apparatus as set forth in claim 18, wherein:
at least one of the analysis results is a color occupancy that represents how much a color of the image signal occupies a screen; and
the gradation conversion control part obtains the color occupancy of the image signal to change the gradation conversion characteristic in accordance with the obtained color occupancy.

27. The image processing apparatus as set forth in claim 1, wherein:
the image processing part comprises a noise suppressing part for suppressing noise in the image signal; and
the control part comprises a noise suppression control part for obtaining noise related information to control a degree of noise suppression of the noise suppressing part in accordance with the obtained noise related information, the noise related information being an influential factor affecting noise representation of the image signal.

28. The image processing apparatus as set forth in claim 27, wherein:
at least one piece of the noise related information is imaging condition(s) for the image signal; and
the noise suppression control part obtains the imaging condition for the image signal to control the degree of noise suppression in accordance with the obtained imaging condition.

29. The image processing apparatus as set forth in claim 27, wherein:
at least one piece of the noise related information is analysis result(s) of the image signal; and
the noise suppression control part obtains the analysis result of the image signal to control the degree of noise suppression in accordance with the obtained analysis result.

30. The image processing apparatus as set forth in claim 28, wherein:
at least one of the imaging conditions is a photometric value of a field; and
the noise suppression control part obtains the photometric value at capture of the image signal to control the degree of noise suppression in accordance with the obtained photometric value.

31. The image processing apparatus as set forth in claim 28, wherein:
at least one of the imaging conditions is a divided photometric value of a field; and
the noise suppression control part obtains the divided photometric value at capture of the image signal to control the degree of noise suppression in accordance with a photometric contrast which is obtained from the divided photometric value.

32. The image processing apparatus as set forth in claim 28, wherein:
at least one of the imaging conditions is information on illumination to an object; and
the noise suppression control part obtains the information on illumination at capture of the image signal to control the degree of noise suppression in accordance with the obtained information on illumination.

33. The image processing apparatus as set forth in claim 28, wherein:
at least one of the imaging conditions is an exposure condition of the imaging part; and
the noise suppression control part obtains the exposure condition at capture of the image signal to control the degree of noise suppression in accordance with the obtained exposure condition.

34. The image processing apparatus as set forth in claim 28, wherein:
at least one of the imaging conditions is information on a lens of the imaging part; and
the noise suppression control part obtains the lens information at capture of the image signal to control the degree of noise suppression in accordance with the obtained lens information.

35. The image processing apparatus as set forth in claim 29, wherein:
at least one of the analysis results is color information on a color of the image signal; and
the noise suppression control part obtains the color information on the image signal to control the degree of noise suppression in accordance with the obtained color information.

36. The image processing apparatus as set forth in claim 29, wherein at least one of the analysis results is a color occupancy that represents how much a color of the image signal occupies a screen; and
the noise suppression control part obtains the color occupancy of the image signal to control the degree of noise suppression in accordance with the obtained color occupancy.

37. The image processing apparatus as set forth in claim 1, wherein:
the control part comprises a chromaticness modulation control part for obtaining color related information to change a chromaticness modulation characteristic in accordance with the obtained color related information, the color related information being an influential factor that affects color representation of the image signal, the chromaticness modulation characteristic defining a gain of a chromaticness level to a luminance level; and
the image processing part comprises a chromaticness modulating part for adjusting the gain of the chromaticness level according to a luminance level of the image signal, in compliance with the chromaticness modulation characteristic which is controlled by the chromaticness modulation control part.

38. The image processing part as set forth in claim 37, wherein at least one piece of the color related information is a degree of an adjustment of the color reproduction made on the image signal; and
the chromaticness modulation control part obtains the degree of the adjustment of the color reproduction to change the chromaticness modulation characteristic in accordance with the obtained degree of the adjustment of the color reproduction.

39. The image processing apparatus as set forth in claim 37, wherein:
at least one piece of the color related information is image sensitivity of the imaging part; and
the chromaticness modulation control part obtains the image sensitivity at capture of the image signal to change the chromaticness modulation characteristic in accordance with the obtained image sensitivity.

40. The image processing apparatus as set forth in claim 37, wherein:
at least one of the color related information is a gradation conversion characteristic given to the image signal; and
the chromaticness modulation control part obtains the gradation conversion characteristic to change the chromaticness modulation characteristic in accordance with the obtained gradation conversion characteristic.

41. An image processing program for causing a computer to function as the image processing part and the control part as set forth in claim 1.

42. An image processing method for performing an image processing on an image signal, comprising the step of:
obtaining an influential factor and controlling a level of the image processing in accordance with the obtained influential factor, the influential factor being a factor that affects a result of the image processing.
